(19) United States
(12) Patent Application Publication
(10) Pub. No.: US 2025/0184206 A1
(43) Pub. Date: Jun. 5, 2025

(54) ASYMMETRIC MODULATION ORDER DESIGN

(71) Applicant: QUALCOMM Incorporated, San Diego, CA (US)

(72) Inventors: Wei YANG, San Diego, CA (US); Jing JIANG, San Diego, CA (US)

(21) Appl. No.: 18/526,227

(22) Filed: Dec. 1, 2023

(51) Int. Cl. H04L 27/36

(52) U.S. Cl. CPC H04L 27/36

(57) ABSTRACT

Methods, systems, and devices for wireless communications are described. A receiving device may receive a grant scheduling a transmission to the receiving device across a set of layers, the grant indicating a combined modulation order associated with the transmission. The receiving device may receive the transmission via the set of layers and according to the combined modulation order, the combined modulation order based on at least two modulation orders used for at least two corresponding layers in the set of layers, wherein the at least two modulation orders are within a threshold level of each other. The receiving device may decode the transmission according to the combined modulation order.

### FIELD OF TECHNOLOGY

The following relates to wireless communications, including asymmetric modulation order design.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support asymmetric modulation order design. For example, the described techniques provide for improved asymmetric modulation orders for multiple-input/multiple-output (MIMO) communications (e.g., multi-layer communications). Broadly, the asymmetric modulation orders may include intermediate sum modulation orders (e.g., modulation order combinations) applied to multi-layer communications. For example, a receiving device (e.g., a user equipment (UE) and/or network entity) may receive a grant that schedules a multi-layer transmission to the UE (e.g., across a set of layers). The grant may carry or convey an indication of a combined modulation order for the transmission. The combined modulation order may be based on two modulation orders used on two layers, where the two modulation orders are within a threshold level of each other. For example, the two layers may use quadrature phase shift keying (QPSK) and 16 quadrature amplitude modulation (QAM) (e.g., modulation and coding scheme (MCS) separated by one level), 16 QAM and 64 QAM, 64 QAM and 256 QAM (e.g., MCS's that are one level apart from each other). The receiving device may receive the transmission across the layers and according to the combined modulation order based on the grant. The receiving device may apply the combined modulation order when decoding the transmission.

Additionally, or alternatively, the described techniques may provide for modified systemic bit prioritization mapping (SBPM) schemes that support asymmetric modulation orders for MIMO communications. For example, a receiving device may receive, determine, or otherwise identify a bit mapping scheme (e.g., the SBPM scheme) used for the transmission. The receiving device may receive the transmission across the set of layers and according to the bit mapping scheme based on the grant. The receiving device may decode the transmission by reading a first set of bits from a first layer using a first modulation order and a second set of bits from a second layer using a second modulation order. This technique may enable mapping the most significant bit (MSB) from the higher modulation order (e.g., 64 QAM) to the better-performing layer(s) and the MSB from the lower modulation order (e.g., 16 QAM) to the remaining layer(s).

A method for wireless communications by a receiving device is described. The method may include receiving a grant scheduling a transmission to the receiving device across a set of layers, the grant indicating a combined modulation order associated with the transmission, receiving the transmission via the set of layers and according to the combined modulation order, the combined modulation order based on at least two modulation orders used for at least two corresponding layers in the set of layers, where the at least two modulation orders are within a threshold level of each other, and decoding the transmission according to the combined modulation order.

A receiving device for wireless communications is described. The receiving device may include one or more memories storing processor executable code, and one or more processors coupled with the one or more memories. The one or more processors may individually or collectively operable to execute the code to cause the receiving device to receive a grant scheduling a transmission to the receiving device across a set of layers, the grant indicating a combined modulation order associated with the transmission, receive the transmission via the set of layers and according to the combined modulation order, the combined modulation order based on at least two modulation orders used for at least two corresponding layers in the set of layers, where the at least two modulation orders are within a threshold level of each other, and decode the transmission according to the combined modulation order.

Another receiving device for wireless communications is described. The receiving device may include means for receiving a grant scheduling a transmission to the receiving device across a set of layers, the grant indicating a combined modulation order associated with the transmission, means for receiving the transmission via the set of layers and according to the combined modulation order, the combined modulation order based on at least two modulation orders used for at least two corresponding layers in the set of layers, where the at least two modulation orders are within a threshold level of each other, and means for decoding the transmission according to the combined modulation order.

A non-transitory computer-readable medium storing code for wireless communications is described. The code may include instructions executable by a processor to receive a grant scheduling a transmission to the receiving device across a set of layers, the grant indicating a combined modulation order associated with the transmission, receive the transmission via the set of layers and according to the combined modulation order, the combined modulation order based on at least two modulation orders used for at least two corresponding layers in the set of layers, where the at least two modulation orders are within a threshold level of each other, and decode the transmission according to the combined modulation order.

Some examples of the method, receiving devices, and non-transitory computer-readable medium described herein may further include operations, features, means, or instructions for receiving an indication of a modulation and coding scheme table associated with multi-layer communications, the modulation and coding scheme table including a set of combined modulation orders that includes the combined modulation order, wherein, to decode the transmission, the one or more processors are individually or collectively operable to execute the code to cause the receiving device to decode the transmission based at least in part on the modulation and coding scheme table.

In some examples of the method, receiving devices, and non-transitory computer-readable medium described herein, each combined modulation order in the set of combined modulation orders may be associated with at least two consecutive modulation order levels, a combination of the at least two consecutive modulation order levels forming the combined modulation order.

In some examples of the method, receiving devices, and non-transitory computer-readable medium described herein, the set of combined modulation orders include a first QPSK modulation and a second QPSK modulation, the first QPSK modulation and a first 16 QAM, the first 16 QAM and a second 16 QAM, the first 16 QAM and a first 64 QAM, the first 64 QAM and a second 64 QAM, the first 64 QAM and a first 256 QAM, the first 256 QAM and a second 256 QAM, the first 256 QAM and a first 1024 QAM, the first 1024 QAM and a second 1024 QAM, the first QAM and a first 4096 QAM, the first 4096 QAM and a second 4096 QAM, or a combination thereof.

Some examples of the method, receiving devices, and non-transitory computer-readable medium described herein may further include operations, features, means, or instructions for receiving an indication of a modulation and coding scheme table associated with single layer communications, the modulation and coding scheme table including a set of modulation orders corresponding to each single layer communication and determining the combined modulation order based on the grant, the threshold level, and a spectral efficiency parameter in the modulation and coding scheme table.

In some examples of the method, receiving devices, and non-transitory computer-readable medium described herein, the combined modulation order may be associated with at least two consecutive modulation order levels, a combination of the at least two consecutive modulation order levels forming the combined modulation order.

In some examples of the method, receiving devices, and non-transitory computer-readable medium described herein, the at least two modulation orders include at least one of QPSK, QAM, or both.

In some examples of the method, receiving devices, and non-transitory computer-readable medium described herein, the transmission across the set of layers includes a jointly coded and encoded transmission.

A method for wireless communications by a receiving device is described. The method may include identifying a bit mapping scheme associated with a transmission across a set of layers, receiving the transmission via the set of layers and according to the bit mapping scheme, the bit mapping scheme based on at least two different modulation orders used for at least two corresponding layers in the set of layers, and decoding the transmission according to the bit mapping scheme through a read of a first set of bits associated with a first modulation order used on a first layer and a read of a second set of bits associated with a second modulation order used on a second layer.

A receiving device for wireless communications is described. The receiving device may include one or more memories storing processor executable code, and one or more processors coupled with the one or more memories. The one or more processors may individually or collectively operable to execute the code to cause the receiving device to identify a bit mapping scheme associated with a transmission across a set of layers, receive the transmission via the set of layers and according to the bit mapping scheme, the bit mapping scheme based on at least two different modulation orders used for at least two corresponding layers in the set of layers, and decode the transmission according to the bit mapping scheme through a read of a first set of bits associated with a first modulation order used on a first layer and a read of a second set of bits associated with a second modulation order used on a second layer.

Another receiving device for wireless communications is described. The receiving device may include means for identifying a bit mapping scheme associated with a transmission across a set of layers, means for receiving the transmission via the set of layers and according to the bit mapping scheme, the bit mapping scheme based on at least two different modulation orders used for at least two corresponding layers in the set of layers, and means for decoding the transmission according to the bit mapping scheme through a read of a first set of bits associated with a first modulation order used on a first layer and a read of a second set of bits associated with a second modulation order used on a second layer.

A non-transitory computer-readable medium storing code for wireless communications is described. The code may include instructions executable by a processor to identify a bit mapping scheme associated with a transmission across a set of layers, receive the transmission via the set of layers and according to the bit mapping scheme, the bit mapping scheme based on at least two different modulation orders used for at least two corresponding layers in the set of layers, and decode the transmission according to the bit mapping scheme through a read of a first set of bits associated with a first modulation order used on a first layer and a read of a second set of bits associated with a second modulation order used on a second layer.

In some examples of the method, receiving devices, and non-transitory computer-readable medium described herein, decoding the transmission according to the bit mapping scheme may include operations, features, means, or instructions for reading first most significant bits associated with the first modulation order, the first most significant bits including the first set of bits and reading second most significant bits associated with the second modulation order, the second most significant bits including the second set of bits.

In some examples of the method, receiving devices, and non-transitory computer-readable medium described herein, the first most significant bits correspond to a first subset of layers that may be associated with a first reliability metric and the second most significant bits correspond to a second subset of layers that may be associated with a second reliability metric that may be a lower reliability metric than the first reliability metric.

In some examples of the method, receiving devices, and non-transitory computer-readable medium described herein, decoding the transmission according to the bit mapping scheme may include operations, features, means, or instructions for reading first most significant bits associated with the first modulation order, the first most significant bits including the first set of bits and reading second most significant bits associated with the second modulation order, the second most significant bits including the second set of bits.

In some examples of the method, receiving devices, and non-transitory computer-readable medium described herein, a second column associated with the second modulation order includes a subset of bits corresponding to a puncturing scheme, a rate matching scheme, or a combination thereof.

In some examples of the method, receiving devices, and non-transitory computer-readable medium described herein, the first most significant bits may be mapped to a first column corresponding to a first subset of layers that may be associated with a first reliability metric and the second most significant bits may be mapped to a second column corresponding to a second subset of layers that may be associated with a second reliability metric that may be a lower reliability metric than the first reliability metric.

A method for wireless communications by a transmitting device is described. The method may include transmitting, to a receiving device, a grant scheduling a transmission to the receiving device across a set of layers, the grant indicating a combined modulation order associated with the transmission and transmitting the transmission via the set of layers and according to the combined modulation order, the combined modulation order based on at least two modulation orders used for at least two corresponding layers in the set of layers, where the at least two modulation orders are within a threshold level of each other.

A transmitting device for wireless communications is described. The transmitting device may include one or more memories storing processor executable code, and one or more processors coupled with the one or more memories. The one or more processors may individually or collectively operable to execute the code to cause the transmitting device to transmit, to a receiving device, a grant scheduling a transmission to the receiving device across a set of layers, the grant indicating a combined modulation order associated with the transmission and transmit the transmission via the set of layers and according to the combined modulation order, the combined modulation order based on at least two modulation orders used for at least two corresponding layers in the set of layers, where the at least two modulation orders are within a threshold level of each other.

Another transmitting device for wireless communications is described. The transmitting device may include means for transmitting, to a receiving device, a grant scheduling a transmission to the receiving device across a set of layers, the grant indicating a combined modulation order associated with the transmission and means for transmitting the transmission via the set of layers and according to the combined modulation order, the combined modulation order based on at least two modulation orders used for at least two corresponding layers in the set of layers, where the at least two modulation orders are within a threshold level of each other.

A non-transitory computer-readable medium storing code for wireless communications is described. The code may include instructions executable by a processor to transmit, to a receiving device, a grant scheduling a transmission to the receiving device across a set of layers, the grant indicating a combined modulation order associated with the transmission and transmit the transmission via the set of layers and according to the combined modulation order, the combined modulation order based on at least two modulation orders used for at least two corresponding layers in the set of layers, where the at least two modulation orders are within a threshold level of each other.

Some examples of the method, transmitting devices, and non-transitory computer-readable medium described herein may further include operations, features, means, or instructions for transmitting an indication of a modulation and coding scheme table associated with multi-layer communications, the modulation and coding scheme table including a set of combined modulation orders that includes the combined modulation order, wherein, to decode the transmission, the one or more processors are individually or collectively operable to execute the code to cause the receiving device to decode the transmission based at least in part on the modulation and coding scheme table.

In some examples of the method, transmitting devices, and non-transitory computer-readable medium described herein, each combined modulation order in the set of combined modulation orders may be associated with at least two consecutive modulation order levels, a combination of the at least two consecutive modulation order levels forming the combined modulation order.

In some examples of the method, transmitting devices, and non-transitory computer-readable medium described herein, the set of combined modulation orders include a first QPSK modulation and a second QPSK modulation, the first QPSK modulation and a first 16 QAM, the first 16 QAM and a second 16 QAM, the first 16 QAM and a first 64 QAM, the first 64 QAM and a second 64 QAM, the first 64 QAM and a first 256 QAM, the first 256 QAM and a second 256 QAM, the first 256 QAM and a first 1024 QAM, the first 1024 QAM and a second 1024 QAM, the first QAM and a first 4096 QAM, the first 4096 QAM and a second 4096 QAM, or a combination thereof.

Some examples of the method, transmitting devices, and non-transitory computer-readable medium described herein may further include operations, features, means, or instructions for transmitting an indication of a modulation and coding scheme table associated with single layer communications, the modulation and coding scheme table including a set of modulation orders corresponding to each communication layer, where the combined modulation order may be based on the grant, the threshold level, and a spectral efficiency parameter in the modulation and coding scheme table.

In some examples of the method, transmitting devices, and non-transitory computer-readable medium described herein, the combined modulation order may be associated with at least two consecutive modulation order levels, a combination of the at least two consecutive modulation order levels forming the combined modulation order.

In some examples of the method, transmitting devices, and non-transitory computer-readable medium described herein, the at least two modulation orders include at least one of QPSK, QAM, or both.

A method for wireless communications by a transmitting device is described. The method may include identifying a bit mapping scheme associated with a transmission across a set of layers and transmitting the transmission via the set of layers and according to the bit mapping scheme, the bit mapping scheme based on at least two different modulation orders used for at least two corresponding layers in the set of layers, where to encode the transmission according to the bit mapping scheme is through a write of a first set of bits associated with a first modulation order used on a first layer and a write of a second set of bits associated with a second modulation order used on a second layer.

A transmitting device for wireless communications is described. The transmitting device may include one or more memories storing processor executable code, and one or more processors coupled with the one or more memories. The one or more processors may individually or collectively operable to execute the code to cause the transmitting device to identify a bit mapping scheme associated with a transmission across a set of layers and transmit the transmission via the set of layers and according to the bit mapping scheme, the bit mapping scheme based on at least two different modulation orders used for at least two corresponding layers in the set of layers, where to encode the transmission according to the bit mapping scheme is through a write of a first set of bits associated with a first modulation order used on a first layer and a write of a second set of bits associated with a second modulation order used on a second layer.

Another transmitting device for wireless communications is described. The transmitting device may include means for identifying a bit mapping scheme associated with a transmission across a set of layers and means for transmitting the transmission via the set of layers and according to the bit mapping scheme, the bit mapping scheme based on at least two different modulation orders used for at least two corresponding layers in the set of layers, where to encode the transmission according to the bit mapping scheme is through a write of a first set of bits associated with a first modulation order used on a first layer and a write of a second set of bits associated with a second modulation order used on a second layer.

A non-transitory computer-readable medium storing code for wireless communications is described. The code may include instructions executable by a processor to identify a bit mapping scheme associated with a transmission across a set of layers and transmit the transmission via the set of layers and according to the bit mapping scheme, the bit mapping scheme based on at least two different modulation orders used for at least two corresponding layers in the set of layers, where to encode the transmission according to the bit mapping scheme is through a 10riting of a first set of bits associated with a first modulation order used on a first layer and a write of a second set of bits associated with a second modulation order used on a second layer.

In some examples of the method, transmitting devices, and non-transitory computer-readable medium described herein, encoding the transmission according to the bit mapping scheme may include operations, features, means, or instructions for writing first most significant bits associated with the first modulation order, the first most significant bits including the first set of bits and writing second most significant bits associated with the second modulation order, the second most significant bits including the second set of bits.

In some examples of the method, transmitting devices, and non-transitory computer-readable medium described herein, the first most significant bits may be mapped to a first row corresponding to a first subset of layers that may be associated with a first reliability metric and the second most significant bits may be mapped to a second row corresponding to a second subset of layers that may be associated with a second reliability metric that may be a lower reliability metric than the first reliability metric.

In some examples of the method, transmitting devices, and non-transitory computer-readable medium described herein, encoding the transmission according to the bit mapping scheme may include operations, features, means, or instructions for writing first most significant bits associated with the first modulation order, the first most significant bits including the first set of bits and writing second most significant bits associated with the second modulation order, the second most significant bits including the second set of bits.

In some examples of the method, transmitting devices, and non-transitory computer-readable medium described herein, a second column associated with the second modulation order includes a subset of bits corresponding to a puncturing scheme, a rate matching scheme, or a combination thereof.

In some examples of the method, transmitting devices, and non-transitory computer-readable medium described herein, the first most significant bits may be mapped to a first column corresponding to a first subset of layers that may be associated with a first reliability metric and the second most significant bits may be mapped to a second column corresponding to a second subset of layers that may be associated with a second reliability metric that may be a lower reliability metric than the first reliability metric.

### BRIEF DESCRIPTION OF THE DRAWINGS

FIG. 1 shows an example of a wireless communications system that supports asymmetric modulation order design in accordance with one or more aspects of the present disclosure.

FIG. 2 shows an example of a wireless communications system that supports asymmetric modulation order design in accordance with one or more aspects of the present disclosure.

FIG. 3 shows an example of a SBPM scheme that supports asymmetric modulation order design in accordance with one or more aspects of the present disclosure.

FIG. 4 shows an example of a systemic bit prioritization mapping (SBPM) scheme that supports asymmetric modulation order design in accordance with one or more aspects of the present disclosure.

FIGS. 5A and 5B show examples of a SBPM scheme that supports asymmetric modulation order design in accordance with one or more aspects of the present disclosure.

FIGS. 6 and 7 show block diagrams of devices that support asymmetric modulation order design in accordance with one or more aspects of the present disclosure.

FIG. 8 shows a block diagram of a communications manager that supports asymmetric modulation order design in accordance with one or more aspects of the present disclosure.

FIG. 9 shows a diagram of a system including a network entity that supports asymmetric modulation order design in accordance with one or more aspects of the present disclosure.

FIG. 10 shows a diagram of a system including a UE that supports asymmetric modulation order design in accordance with one or more aspects of the present disclosure.

FIGS. 11 through 14 show flowcharts illustrating methods that support asymmetric modulation order design in accordance with one or more aspects of the present disclosure.

### DETAILED DESCRIPTION

Wireless networks may use multiple-input/multiple-output (MIMO) techniques to communicate across different layers. The different layers may include spatial layers, antenna configurations, antenna ports, or similar features. MIMO techniques may include a codeword (e.g., original user data) being mapped to multiple layers, where the different layers may use the same or different modulation orders. Such techniques, however, are based on the knowledge of the channel conditions of each layer. That is, the user equipment (UE) and the network entity may perform channel measurement and reporting procedures where the UE and/or network entity measure the channel performance per-layer. Such networks select the modulation and coding scheme (MCS) to be applied to the MIMO communications based on the results of the channel measurement and reporting procedures.

The described techniques relate to improved methods, systems, devices, and apparatuses that support asymmetric modulation order design. For example, the described techniques provide for improved asymmetric modulation orders for MIMO communications (e.g., multi-layer communications). Broadly, the asymmetric modulation orders may include intermediate sum modulation orders (e.g., modulation order combinations) applied to multi-layer communications. For example, a receiving device (e.g., a UE and/or network entity) may receive a grant that schedules a multi-layer transmission to the UE (e.g., across a set of layers). The grant may carry or convey an indication of a combined modulation order for the transmission. The combined modulation order may be based on two modulation orders used on two layers, where the two modulation orders are within a threshold level of each other. For example, the two layers may use quadrature phase shift keying (QPSK) and 16 quadrature amplitude modulation (QAM) (e.g., modulation and coding scheme (MCS) separated by one level), 16 QAM and 64 QAM, 64 QAM and 256 QAM (e.g., MCS's that are one level apart from each other). The receiving device may receive the transmission across the layers and according to the combined modulation order based on the grant. The receiving device may apply the combined modulation order when decoding the transmission.

Additionally, or alternatively, the described techniques may provide for modified systemic bit prioritization mapping (SBPM) schemes that support asymmetric modulation orders for MIMO communications. For example, a receiving device may receive, determine, or otherwise identify a bit mapping scheme (e.g., the SBPM scheme) used for the transmission. The receiving device may receive the transmission across the set of layers and according to the bit mapping scheme based on the grant. The receiving device may decode the transmission by reading a first set of bits from a first layer using a first modulation order and a second set of bits from a second layer using a second modulation order. This technique may enable mapping the most significant bit (MSB) from the higher modulation order (e.g., 64 QAM) to the better-performing layer(s) and the MSB from the lower modulation order (e.g., 16 QAM) to the remaining layer(s).

Aspects of the disclosure may improve multi-layer transmissions (e.g., MIMO transmissions) be removing the capacity loss associated with transition points between different modulation orders. For example, the present disclosure provides a mechanism where combined modulation orders are applied to the multi-layer transmissions without being based on per-layer channel performance information. The SBPM techniques further combined modulation orders being applied by improving the channel mapping techniques for multi-layer communications.

Aspects of the disclosure are initially described in the context of wireless communications systems. Aspects of the disclosure are further illustrated by and described with reference to apparatus diagrams, system diagrams, and flowcharts that relate to asymmetric modulation order design.

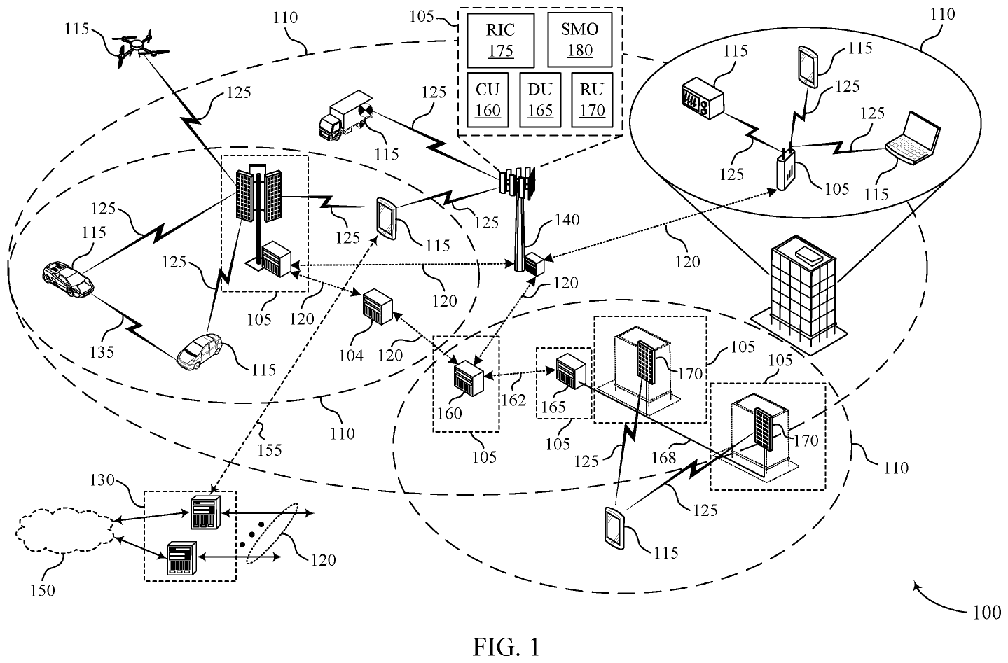

FIG. 1 shows an example of a wireless communications system 100 that supports asymmetric modulation order design in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support asymmetric modulation order design as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A receiving device (e.g., a UE 115 and/or a network entity 105) may receive a grant scheduling a transmission to the receiving device across a set of layers, the grant indicating a combined modulation order associated with the transmission. The receiving device may receive, according to the grant, the transmission via the set of layers and according to the combined modulation order, the combined modulation order based on at least two modulation orders used for at least two corresponding layers in the set of layers, wherein the at least two modulation orders are within a threshold level of each other. The receiving device may decode the transmission according to the combined modulation order.

A receiving device (e.g., a UE 115 and/or a network entity 105) may identify a bit mapping scheme associated with a transmission across a set of layers. The receiving device may receive the transmission via the set of layers and according to the bit mapping scheme, the bit mapping scheme based on at least two different modulation orders used for at least two corresponding layers in the set of layers. The receiving device may decode the transmission according to the bit mapping scheme, wherein the decoding comprises reading a first set of bits associated with a first modulation order used on a first layer and reading a second set of bits associated with a second modulation order used on a second layer.

A transmitting device (e.g., a UE 115 and/or a network entity 105) may transmit, to a receiving device, a grant scheduling a transmission to the receiving device across a set of layers, the grant indicating a combined modulation order associated with the transmission. The transmitting device may transmit, according to the grant, the transmission via the set of layers and according to the combined modulation order, the combined modulation order based on at least two modulation orders used for at least two corresponding layers in the set of layers, wherein the at least two modulation orders are within a threshold level of each other.

A transmitting device (e.g., a UE 115 and/or a network entity 105) may identify a bit mapping scheme associated with a transmission across a set of layers. The transmitting device may transmit the transmission via the set of layers and according to the bit mapping scheme, the bit mapping scheme based on at least two different modulation orders used for at least two corresponding layers in the set of layers, wherein encoding the transmission according to the bit mapping scheme comprises writing a first set of bits associated with a first modulation order used on a first layer and writing a second set of bits associated with a second modulation order used on a second layer.

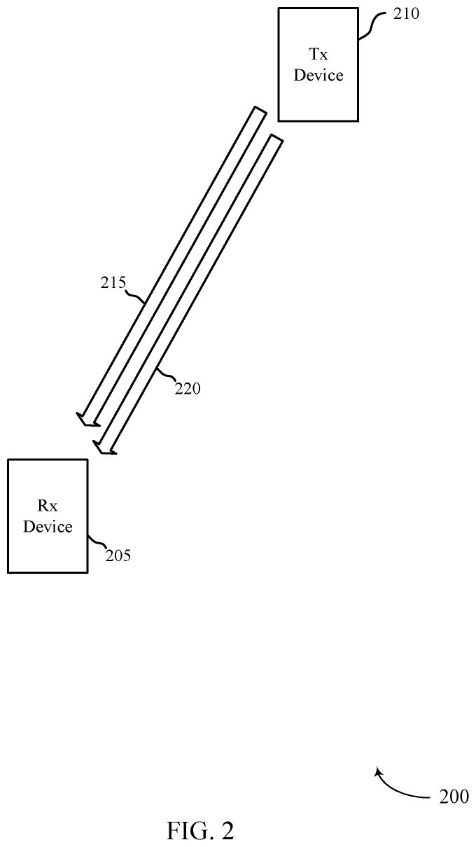

FIG. 2 shows an example of a wireless communications system 200 that supports asymmetric modulation order design in accordance with one or more aspects of the present disclosure. Wireless communications system 200 may implement aspects of wireless communications system 100. Wireless communications system 200 may include a receiving device 205 and/or a transmitting device 210, which may be examples of the corresponding devices described herein. For example, the receiving device 205 and/or the transmitting device 210 may be examples of a UE and/or a network entity.

The wireless communications system 200 may support MIMO communications (e.g., communications across multiple MIMO layers). For example, one codeword (e.g., blocks with joint encoding) may be mapped to multiple MIMO layers using the same modulation order. The modulation order generally defines the MCS used to encode the data (e.g., bits) of the codeword. Examples of a modulation order include, but are not limited to, quadrature phase shift keying (QPSK)-based modulation, quadrature amplitude modulation (QAM)-based modulation, and the like. Some networks support one codeword being mapped to up to two layers while other networks support the codeword being mapped to up to four layers.

For a device receiving MIMO communications, the device detects and recovers the MIMO transmissions from the transmitting device across the wireless channel. Some examples of MIMO detection may include use of a non-linear demodulator (e.g., using maximum likelihood, sphere decoding, power-spectral density, or similar techniques). Use of the non-linear demodulator may rely on the modulation orders applied to the signal layer and the interference layer for detection performance. For example and for the same signal and interference power, detection under QPSK interference may have a better performance than detection under 256QAM interference.

Using the same modulation order on different MIMO layers may simplify the transmit/receive chain to some degree. However, this approach may have performance losses compared to the case in which different modulation orders are used on different layers.

Accordingly, aspects of the techniques described herein provide for system designs to enable the use of different modulation orders on different MIMO layers (e.g., MIMO layers carrying the same codeword). That is, there may be a capacity loss for conventional uniform modulation orders during the modulation order switching point. Aspects of the techniques described herein reduces the capacity loss at the switching points by adding intermediate modulation orders. For example, a combined modulation order may include, but is not limited to, a 16QAM on one layer and 64QAM on a second layer (e.g., a modulation order corresponding to each layer). Some aspects of these techniques may include using different modulation orders on different spatial/MIMO layers for transmitted modulated symbols associated with the same codeblock/codeword and the same time/frequency resources (e.g., the same OFDM symbols and the same resource element).

As one non-limiting example, this may include a two layer MIMO scenario with 256QAM (that conveys eight bits) on one layer (e.g., 256QAM corresponding to a first layer) and 64QAM (that conveys six bits) on the other layer (e.g., 64QAM corresponding to a second layer). The two layers may be jointly encoded with a channel code (e.g., low-density parity check (LDPC) or polar coding) with a coding rate of R. This may result in a total spectral efficiency of (6+8) R or 14R, in this example.

Some wireless networks may use different modulation orders on different MIMO layers. Such networks, however, schedule the modulation orders based on the channel condition of each spatial layer (e.g., higher modulation orders may be scheduled on layers with strong channel gain). However, such techniques use accurate channel state information (CSI) available at the transmitter to set the channel gain of each layer. In FDD systems, the UE provides feedback information for the precoder and the average CSI across layers (e.g., rather than per-layer), which may leave the network without the respective per-layer channel gain information for the different layers.

Conversely, the techniques described herein improves MIMO performance in the situation where the channel gain of each layer is not available or otherwise unknown at the transmitter. That is, the techniques described herein introduce an intermediate sum modulation order (e.g., by modulation order combinations) instead of adapting the modulation orders based on the per-layer channel gain. These techniques optimize the sum modulation order across different layers.

For example, at 215 the transmitting device 210 may transmit or otherwise provide (and the receiving device 205 may receive or otherwise obtain) a grant scheduling a transmission to the receiving device 205. The transmission may be scheduled across a set of layers, such as MIMO/spatial layers. The grant may carry or otherwise convey an indication of a combined modulation order associated with the transmission. For example, the grant may schedule a MIMO transmission on the set of layers (e.g., the layers of the MIMO transmission). The grant may be an uplink grant, a downlink grant, or a sidelink grant.

At 220, the transmitting device 210 may transmit or otherwise provide (and the receiving device 205 may receive or otherwise obtain) the transmission via the set of layers according to the combined modulation order. The transmissions may be provided according to the grant. The combined modulation order may be based, at least to some degree, on two (or more) modulation orders used for two (or more) layers in the set of layers. The two modulation orders may be within a defined threshold range of each other (e.g., may be based on consecutive modulation orders). The receiving device 205 may decode the transmission according to the combined modulation order.

That is, modulation orders (e.g., MCSs) available for the transmitting device 210 to use for encoding the codeword may begin at QPSK modulation and then progress upwards (e.g., increase in bit-capacity) to 16QAM, 64QAM, 256QAM, 1024QAM, 4096QAM, and onwards. Two modulation orders may be consecutive modulation orders if they are next to each other (e.g., 16QAM and 64QAM are consecutive modulation orders, but 16QAm and 256QAM are non-consecutive modulation orders) within this list. For example, two consecutive modulation orders may include two (e.g., first and second) QPSK modulations, QPSK+16QAM modulations, two 16QAM modulations, 16QAM+64QAM modulations, two 64QAM modulations, 64QAM+256QAM modulations, two 256QAM modulations, 256QAM+1024QAM modulations, two 1024 modulations, 1024QAM+4096QAM modulations, and the like. A combined modulation order may be formed using two, consecutive modulation orders. The combined modulation order may be the two, consecutive modulation orders (e.g., 64QAM+256QAM) or may be formed based on a combination of the two modulation orders (e.g., 64QAM+64QAM). In some examples, the combined modulation order may begin at binary phase shift keying (BPSK) or pi/2BPSK (e.g., one bit per modulation symbol) and then move to QPSK (e.g., two bits per modulation symbol).

In some aspects, this may include the receiving device 205 receiving or otherwise obtaining (and the transmitting device 210 transmitting or otherwise providing) an indication of an MCS table associated with multi-layer communications (e.g., a new, multi-layer MCS table design). The multi-layer MCS table in this example may carry or otherwise convey an indication of information identifying a set of combined modulation orders that may include the combined modulation order. As discussed above, each combined modulation order in the set may be associated with at least two, consecutive modulation order levels. A combination of the two modulation order levels may be used to form the combined modulation order.

Accordingly, this example may include a new MCS table design. The per-layer modulation orders may be signaled together with new MCS tables designed specifically for MIMO. In this case, there may be different MCS tables for different MIMO layers. For example and for a two layer MIMO, the new MCS table may signal combinations of modulation orders per MCS entry, together with the indication of the coding rate. As discussed above, the combinations of modulation orders may include, but are not limited to, QPSK+QPSK, QPSK+16QAM, 16QAM+16QAM, 16QAM+64QAM, 64QAM+64QAM, 64QAM+256QAM, 256QAM+256QAM, and so forth.

More particularly, the techniques described herein do not use arbitrary modulation order combinations/pairs (e.g., modulation orders based on the channel gain of each layer). Instead, the techniques described herein use modulation order pairs that differ by at most one level. Also, the ordering of the modulation orders in the combination is not important (e.g., there is no difference between QPSK+16QAM compared to 16QAM+QPSK).

In some aspects, the new MCS table may indicate the sum modulation orders. For example, the new MCS table may indicate QPSK+QPSK=4 (bit/s/Hz), QPSK+16QAM=6 (bit/s/Hz), 16QAM+16QAM=8 (bit/s/Hz), 16QAM+64QAM=10 (bit/s/Hz), and so forth. The decomposition from the sum modulation order is unique by design. That is, if the sum modulation order (e.g., the combined modulation order) divides by four, then this is an equal modulation order across the two layers. Otherwise, there may be an unequal modulation order across the two MIMO layers. In some aspects, the coding rates may be defined for each MCS (modulation order combinations).

One non-limiting example may be based on S as the sum modulation orders and L as the number of layers. This may include using: m_min=floor (S/(2L)*2 to determine or otherwise identify the minimum modulation order across layers. Then, add the remainders (S−L*m_min) uniformly to a subset of the layers L_+=(S−L*m_min)/2 layers to increase the modulation order by two on each of these layers. For example, if the sum modulation order across layers S=12, and L−4 layers, the minimum modulation order may be given as: m_min−Floor (12/(2*4))*2−2. Next, adding the remainders may provide S−m_min*L=12−2*4=4. This means that there may be four modulation orders to spare. In this case, there may be two layers having a higher modulation order than the rest of the two layers. The layer allocation, in this example, may be 2,2,4,4, resulting in a combined modulation order of 2+2+4+4=12.

It is to be understood that aspects of these techniques may be implemented for more than two layers. This scenario provides greater flexibilities to assign the modulation orders between different layers. For example and for a four layer case, the following modulation order combinations across the four layers may be used: 4×QPSK, 3×QPSK+16QAM, 2×QPSK, 2×16QAM, 1×QPSK->3×16QAM, 4×16QAM, and so forth. The techniques discussed above apply to this two-plus layer scenario based on the combined modulation orders that are within the threshold range of each other (e.g., consecutive). Additionally, in the scenario with more than two layers, there may be at most two different modulation orders across all layers. Therefore, this may not result in a situation with 2,4,6,6 modulation orders on four different modulation layers (e.g., QPSK and 64QAM are not within a threshold level of each other). Instead, this may result in 4,4,4,6 (with the same sum modulation order layer) as the combined modulation order.

In some aspects, this may include the receiving device 205 receiving or otherwise obtaining (and the transmitting device 210 transmitting or otherwise providing) an indication of an MCS table associated with single layer communications. That is, the MCS table may include a set of modulation orders corresponding to each single layer communication. The receiving device 205 may identify or otherwise determine the combined modulation order based on the grant, the threshold level, and a spectral efficiency parameter in the MCS table.

More particularly, aspects of the techniques described herein may build on the legacy MCS table (defined for SISO, and assuming the same modulation order across MIMO layers when used in a MIMO case). For each entry of the legacy MCS table, this may include keeping the same spectral efficiency, and changing the modulation order and coding rate to match the spectral efficiency. For example, MCS 20 entry in the 256QAM MCS table may be associated with a modulation order of eight (i.e., 8 bits are conveyed in 256QAM) per layer, and coding rate of R=0.6665. The techniques described herein may replace this entry with a modulation order of 6+8 (e.g., a 64QAM modulation order on one layer carrying six bits and a 256QAM modulation order on a second layer carrying eight bits). The coding rate for this entry may be changed to R=0.6665*16/14-0.7617. The scheduler (e.g., the network) may indicate dynamically whether asymmetric modulation orders (e.g., the combined modulation order) are being used or not (e.g., in the grant). If so, then the transmitting device 210 and the receiving device 205 may derive the modulation orders from the legacy MCS table.

In some examples, not all entries of the legacy MCS table need to be changed to support asymmetric modulation orders. For example, for MCSs 23-27, changing the modulation order from 8+8 to 6+8 may result in a very high coding rate (e.g., R=0.9386 for MCS 24, and R=0.9877 for MCS 25), which may suffer from limited coding gain.

Accordingly, aspects of the techniques described herein provide for asymmetric modulation order designs based on a combined modulation order. The combined modulation order may be based on consecutive modulation orders for the multi-layer transmissions, where the consecutive modulation orders are next to each other (e.g., within one level of each other).

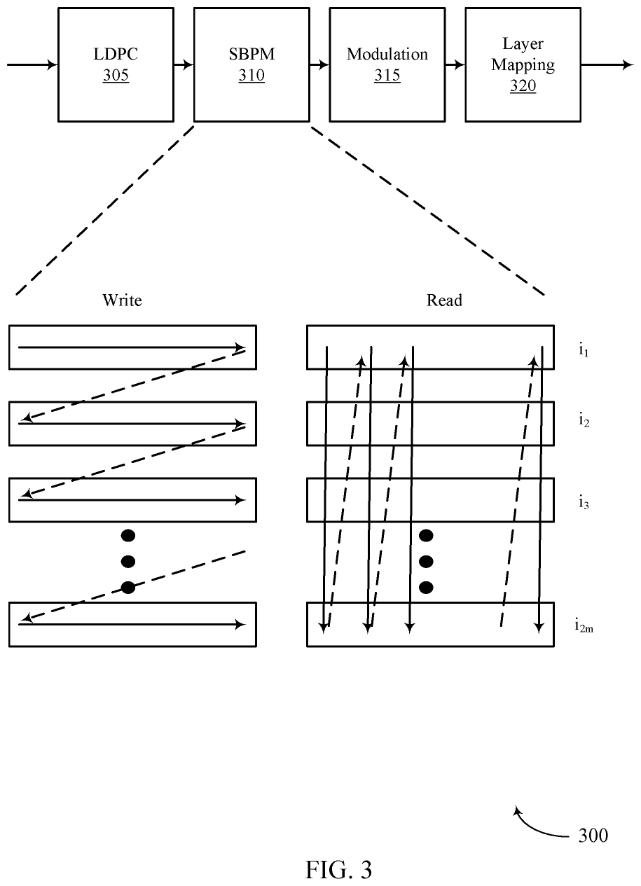

FIG. 3 shows an example of a SBPM scheme 300 that supports asymmetric modulation order design in accordance with one or more aspects of the present disclosure. SBPM scheme 300 may implement aspects of wireless communications system 100 and/or wireless communications system 200. Aspects of SBPM scheme 300 may be implemented at or implemented by a receiving device and/or a transmitting device, which may be examples of the corresponding devices described herein. For example, the receiving device and/or the transmitting device may be examples of a UE and/or network entity.

Some wireless networks may use SBPM techniques where the systematic bits of the forward error correction (FEC) (e.g., channel code, such as LDPC 305) are mapped to the most reliable bit locations of the modulation symbol while the parity bits are mapped to the less reliable bit locations. For example, the codeword (e.g., data bits being communicated across the set of layers) may be provided to the LDPC 305 that generally performs channel coding on the bits. The channel coded bits are output to the SBPM 310 that generally writes the bits according to the prioritization mapping.

For example and starting at layer i₁, the SBPM 310 may write the most significant bit(s) (MSB)(s) to this layer. The layer i₁ in this example corresponds to the most reliable layer, with layer i₂ being the second most reliable layer, with layer i₃ being the third most reliable layer, and so forth. Accordingly, the SBPM 310 may write the systematic bits to layer i₁ first and then write the second set of systematic bits to the layer i₂. This may continue with the SBPM 310 writing in a row-first manner until the parity bits are finally added to the least reliable layer (e.g., among the set of layers). The receiving device generally recovers these bits by reading them in a column-first manner, as shown in FIG. 3.

The channel coded and mapped bits are output to the modulation 315 that modulates the bits (e.g., using a modulation order). The modulated bits and then provided to the layer mapping 320 to be mapped to physical and/or logical channels before transmission to the receiving device.

However, these techniques are generally based on the same modulation order being used for each codeblock (e.g., the same modulation order is applied across the different layers in the set of layers). As discussed above, aspects of the techniques described herein provide for using combined modulation order(s) (e.g., based on consecutive modulation orders). The combined modulation orders may be based on two modulation orders that are within a threshold range of each other. The threshold range in this example may include modulation orders that are next to each other (e.g., QPSK+16QAM).

Accordingly, aspects of the techniques described herein provide for improved SBPM techniques, such as when two (or more) different modulation orders are used for two (or more) layers in the set of layers used for the transmission. For example, a transmitting and/or receiving device may identify or otherwise determine a bit mapping scheme (e.g., a SBPM bit mapping scheme) associated with a transmission across a set of layers. The transmitting device may transmit (and the receiving device may receive) the transmission across the set of layers according to the bit mapping scheme. As discussed, the bit mapping scheme may be based on the two modulation orders being used on different layers in the set. The receiving device may recover the bits (e.g., decode the transmission) according to the bit mapping scheme. For example, the receiving device may read a first set of bits associated with a first modulation order (or the two) used on a first layer (e.g., the highest reliability layer) and then reading a second set of bits associated with a second modulation order used on a second layer.

That is, the SBPM bit mapping scheme described herein may provide for mapping the highest priority bits (e.g., the MSB(s)) from the highest capacity modulation order (e.g., 16QAM) to the most reliable/best performing layer in the set. The highest priority bits from the second highest capacity modulation order (e.g., QPSK) may be mapped to the next most reliable/better performing layer in the set. This may continue with the lowest priority bits (e.g., least significant bit (LSB)) to the least reliable/worst performing layer in the set.

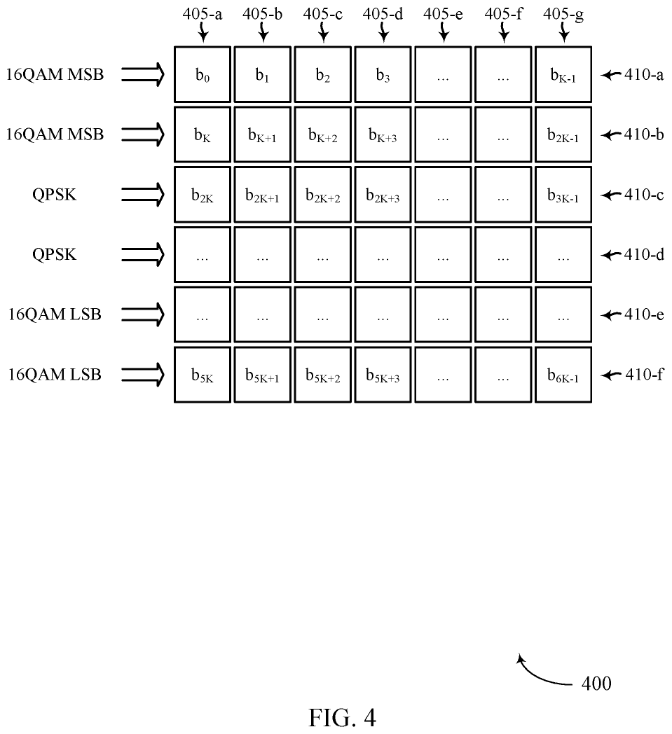

FIG. 4 shows an example of a SBPM scheme 400 that supports asymmetric modulation order design in accordance with one or more aspects of the present disclosure. SBPM scheme 400 may implement aspects of wireless communications system 100 and/or wireless communications system 200 and/or may implement aspects of SBPM scheme 300. Aspects of SBPM scheme 400 may be implemented at or implemented by a receiving device and/or a transmitting device, which may be examples of the corresponding devices described herein. For example, the receiving device and/or the transmitting device may be examples of a UE and/or network entity.

As discussed above, aspects of the techniques described herein provide for an improved bit mapping scheme applied to multi-layer communications. The bit mapping scheme may be based on two (or more) different modulation orders being applied to two (or more) corresponding layers from the set of layers. The two (or more) modulation orders may be consecutive modulation orders (e.g., within a threshold range of each other, such as QPSK+16QAM or 16QAM+64QAM). The receiving device may receive the multi-layer transmission across the set of layers and according to the bit mapping scheme. That is, the transmitting device may apply the bit mapping scheme to the bits (e.g., codeword) being conveyed in the transmission, such as according to SBPM techniques. The receiving device may decode the transmission according to the bit mapping scheme by reading a first set of bits associated with a first modulation order used on a first layer in the set and then reading a second set of bits associated with a second modulation order on a second layer.

SBPM scheme 400 illustrates a non-limiting example of the bit mapping scheme according to the techniques described herein. In particular, SBPM scheme 400 illustrates an example of an SBPM bit mapping scheme (e.g., a channel coding scheme) that may be applied to the multi-layer transmission of a codeword. In this example, the two modulation orders include QPSK modulation and 16QAM modulation being applied to the multi-layer transmission. QPSK is generally associated with two bits that can be carried on two modulation layers (e.g., two bits per modulation symbol) and 16QAM is generally associated with four bits (two MSB bits and two LSB bits) that can be carried on four modulation layers. Thus, the set of layers in this non-limiting example of a multi-layer transmission includes six spatial layers. Each modulation layer may be associated with a reliability metric such that some modulation layers may have better reliability than the other modulation layers.

In this example, layer 410-a may be the best performing spatial layer (e.g., has a first reliability metric) from among the set of spatial layers. Layer 410-b is the next best performing spatial layer from among the set of spatial layers. This may continue with the remaining layers such that layer 410-c is the third best performing spatial layer, layer 410-d is the fourth best performing spatial layer, layer 410-e is the fifth best performing spatial layer, and layer 410-f is the worst performing spatial layer from among the set of spatial layers. It is to be understood that the combined modulation order may use more or less than six spatial layers, such as when higher-order or lower-order modulation orders (e.g., modulation layers) are used.

SBPM scheme 400 illustrates an example where the bit mapping scheme defines how the transmitting device writes the codeword (e.g., bits) to channels (e.g., spatial layers) and/or the receiving device reads the codeword from the multi-layer transmission (e.g., the multi-spatial layer transmission). In particular, SBPM scheme 400 applies the SBPM techniques with respect to the combined modulation orders discussed herein. The bit mapping scheme shown in FIG. 4 includes reordering the MSBs/LSBs corresponding to different modulation orders based on the reliability metric of each spatial layer (e.g., at the coding rate corresponding to the MCS level and/or at a reference coding rate/SNR). This reordering applies greater priority to the MSBs of the 16QAM modulation over the QPSK bits (e.g., 16QAM MSB>QPSK) and greater priority to the two QPSK bits over the 16QAM LSBs (e.g., QPSK>16QAM LSB).

However, in another example the MSBs of the lower modulation order may be prioritized over the MSBs of the higher modulation order (e.g., QPSK>16MSB>16LSB). That is, in some examples the MSBs of the lower modulation order (QPSK, in this example) may have a greater priority than the LSBs of the mower modulation order, which may have a greater priority than the MSBs of the higher order modulation order, which may then have a greater priority than the LSBs of the higher order modulation order. In the situation with greater than two spatial layers, the MSBs of the lower modulation orders may be grouped. For example, with three modulation layers the modulation orders used are 16QAM, 16QAM, and 64QAM, the priority scheme may group the MSBs of the lower order modulation orders. As discussed, the 16QAM may have two MSBs and two LSBs (e.g., four bits) while the 64QQAM may have four MSBs and two LSBs (e.g., six bits). Accordingly, the priority may be 16QAM1_MSB>16QAM2_MSB>16QAM1_LSB>16QAM2_LSB>64QAM_MSB>64QAM_2ndMSB>64QAM_LSB.

Thus, the transmitting device may write (e.g., in a row-first manner) the MSBs (e.g., bits b₀ to b_{K-1} and bits b_{K} to b_{2K-1}) of the 16QAM modulation to layer 410-a and layer 410-b (e.g., the two best performing spatial layers having the highest reliability metric), respectively. The transmitting device may write the QPSK bits (e.g., bits b_{3K} to b_{4K-1} and bits b_{4K} to b_{K-1}) to layer 410-c and to layer 410-d (e.g., the third and fourth best performing spatial layers), respectively. The transmitting device may write the 16QAM LSBs to layer 410-e and layer 410-f (e.g., the worst two performing spatial layers 410). The transmitting device may write the bits during a set of symbols scheduled for the multi-layer transmission. For example, the set of symbols may include first symbol 405-a, second symbol 405-b, third symbol 405-c, fourth symbol 405-d, fifth symbol 405-e, sixth symbol 405-f, and seventh symbol 405-g. It is to be understood that a different number of symbols may be scheduled or otherwise allocated to the multi-layer transmission. That is, aspects of the techniques described herein provide for a row-in/column-out interleaver applied across the sum of the modulation orders across all layers. Therefore, the number of rows in the interleaver may be m1+m2+ . . . . ML (e.g., instead of m for the modulation order of one layer).

At the receiving device, the bits may be read according to the bit mapping scheme. For example, the receiving device may read first MSBs (e.g., the MSBs of the 16QAM modulation order) associated with the first modulation order (e.g., 16QAM, in this example) and then read second MSBs (e.g., the QPSK bits) associated with the second modulation order (e.g., QPSK, in this example). The receiving device may then read the LSBs of the first modulation order (when applicable) to decode the multi-layer transmission. As discussed, the first MSBs may correspond to a first subset of layers (e.g., layer 410-a and layer 410-b) that are associated with a first reliability metric and the second MSBs may correspond to a second subset of layers (e.g., layer 410-c and layer 410-d) that are associated with a second reliability metric. The first reliability metric may be a higher reliability metric than the second reliability metric (e.g., layer 410-a is a better performing layer than layer 410-c).

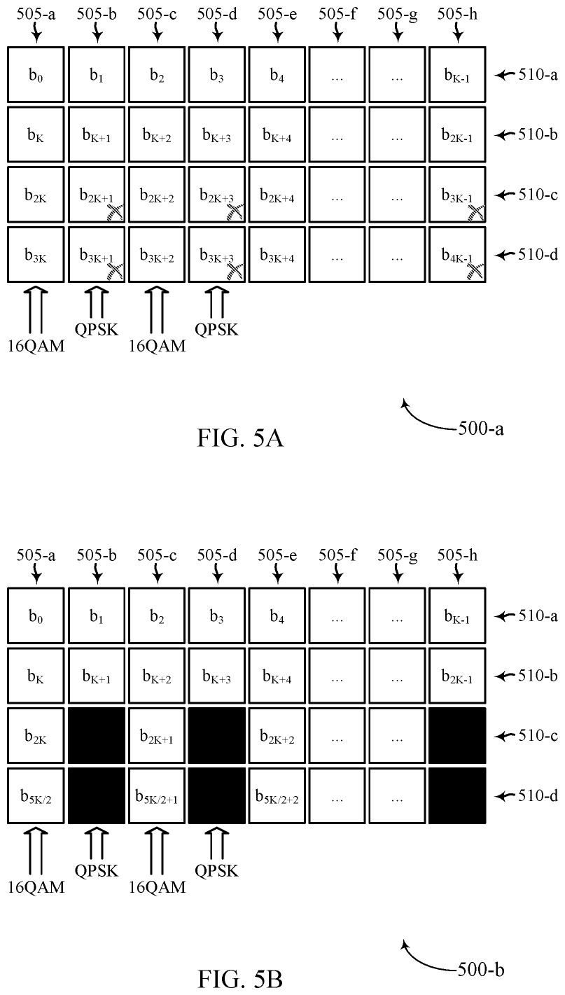

FIGS. 5A and 5B show examples of a SBPM scheme 500 that supports asymmetric modulation order design in accordance with one or more aspects of the present disclosure. SBPM scheme 500 may implement aspects of wireless communications system 100 and/or wireless communications system 200 and/or may implement aspects of SBPM scheme 300 and/or SBPM scheme 400. Aspects of SBPM scheme 500 may be implemented at or implemented by a receiving device and/or a transmitting device, which may be examples of the corresponding devices described herein. For example, the receiving device and/or the transmitting device may be examples of a UE and/or network entity. SBPM scheme 500-a of FIG. 5A illustrates a non-limiting example of a bit mapping scheme using puncturing and SBPM scheme 500-b of FIG. 5B illustrates a non-limiting example of a bit mapping scheme using rate matching.

As discussed above, aspects of the techniques described herein provide for an improved bit mapping scheme applied to multi-layer communications. The bit mapping scheme may be based on two (or more) different modulation orders being applied to two (or more) corresponding layers from the set of layers. The two (or more) modulation orders may be consecutive modulation orders (e.g., within a threshold range of each other, such as QPSK+16QAM or 16QAM+64QAM). The receiving device may receive the multi-layer transmission across the set of layers and according to the bit mapping scheme. That is, the transmitting device may apply the bit mapping scheme to the bits (e.g., codeword) being conveyed in the transmission, such as according to SBPM techniques. The receiving device may decode the transmission according to the bit mapping scheme by reading a first set of bits associated with a first modulation order used on a first layer in the set and then reading a second set of bits associated with a second modulation order on a second layer.

Generally, SBPM scheme 500 illustrates a non-limiting example of the transmitting device interleaving the different modulation orders in the column domain (e.g., during symbols 505) and then applying SBPM techniques with puncturing (FIG. 5A) and with rate matching (FIG. 5B). For example, the bits of the codeword may be written to different layers 510 according to the bit mapping scheme. This may include the first MSBs being mapped to a first column (e.g., symbol 505-a) corresponding to a first subset of layers. Second MSBs may be mapped to a second column corresponding to a second subset of layers. The transmitting device may continue writing the bits according to the bit mapping scheme for layer 510-a and layer 510-b.

The transmitting device may write the bits during a set of symbols scheduled for the multi-layer transmission. For example, the set of symbols may include first symbol 505-a, second symbol 505-b, third symbol 505-c, fourth symbol 505-d, fifth symbol 505-e, sixth symbol 505-f, seventh symbol 505-g, and eights symbol 505-h. It is to be understood that a different number of symbols may be scheduled or otherwise allocated to the multi-layer transmission.

SBPM scheme 500-a of FIG. 5A illustrates a non-limiting example of where a subset of bits correspond to a puncturing scheme. In particular, the subset of bits in this example includes bit b_{2K+1} of layer 510-c and bit b_{3K+1} of layer 510-d during symbol 505-b, bit b_{2K+3} of layer 510-c and bit b_{3K+3} of layer 510-d, and bit b_{3K-1} of layer 510-c and bit b_{4K-1} of layer 510-d during symbol 505-g being punctured. In this example, the coded bits are first written to a block interleaver assuming that the modulation order is equal to the maximum modulation orders of the layers. This may indicate that “rate matching” may be performed twice. For the first time, the UE may first rate match the channel encoder output to a first number of coded bits in each code block, where the first number is equal to m_max*L*n_RE, where m_max is the max modulation order across layers, L is number of layers, n_RE is the number of resource element allocated for each codeblock (CB). In the second rate matching, the UE may further puncture some bits on the layers that are associated with a lower modulation order, as we discussed with reference to FIG. 5A. Next, the bits on the column corresponding to the lowest modulation orders (e.g., QPSK, in this example) are punctured.

SBPM scheme 500-b of FIG. 5B illustrates a non-limiting example where the subset of bits corresponds to a rate matching scheme. In particular, the subset of bits in this example corresponds to bit b_{2K+1} of layer 510-c and bit b_{3K+1} of layer 510-d during symbol 505-b, bit b_{2K+3} of layer 510-c and bit b_{3K+3} of layer 510-d, and bit b_{3K-1} of layer 510-c and bit b_{4K-1} of layer 510-d during symbol 505-g being rate matched around. In this example, the coded bits are first written to the table with unequal column lengths and using the row in/column out principle. However, the bits on the column corresponding to the lowest modulation orders (e.g., QPSK, in this example) and omitted. Instead, those resources are used for rate matching according to the rate matching scheme. In some aspects, the rate matching scheme discussed herein may include the transmitter generating a number of coded bits per codeblock according to the sum modulation order across layers (e.g., using (m1+, . . . , m_L)*n_RE, wherein m1, . . . , m_L denotes the modulation order for each of the L layers.

It is to be understood that the rate matching discussed with reference to FIG. 5B may differ from the rate matching discussed with reference to FIG. 5A. The rate matching discussed with reference to FIG. 5A refers to a “rate matching technique” for channel coding, where a second number of coded bits is generated from a first number of coded bits. The general rate matching schemes for coding may include puncturing (removing bits from the first number of bits), shortening (also removing bits), and repetition (adding more bits from the first number of bits by repeating). The rate matching discussed with reference to FIG. 5B may be different in that these techniques place the bits around the unavailable positions.

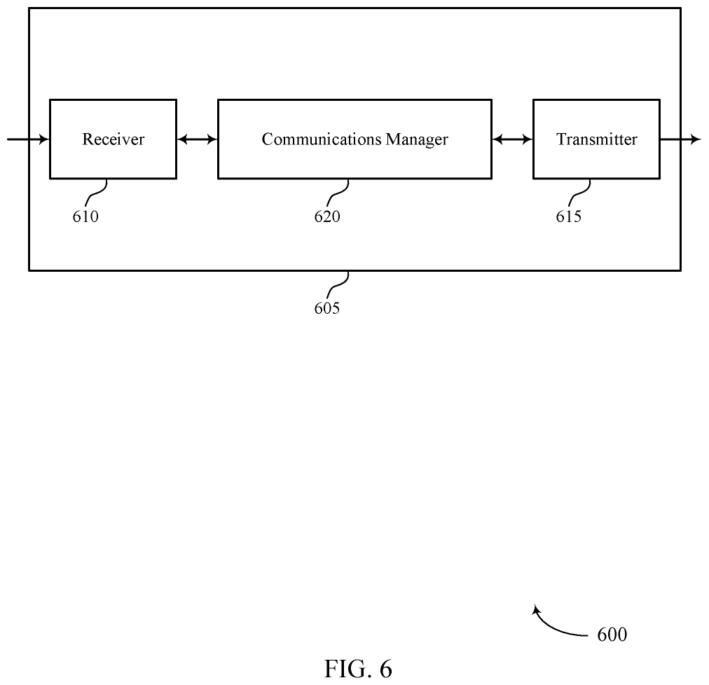

FIG. 6 shows a block diagram 600 of a device 605 that supports asymmetric modulation order design in accordance with one or more aspects of the present disclosure. The device 605 may be an example of aspects of a UE 115 or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to asymmetric modulation order design). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to asymmetric modulation order design). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of asymmetric modulation order design as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a grant scheduling a transmission to the receiving device across a set of layers, the grant indicating a combined modulation order associated with the transmission. The communications manager 620 is capable of, configured to, or operable to support a means for receiving, according to the grant, the transmission via the set of layers and according to the combined modulation order, the combined modulation order based on at least two modulation orders used for at least two corresponding layers in the set of layers, where the at least two modulation orders are within a threshold level of each other. The communications manager 620 is capable of, configured to, or operable to support a means for decoding the transmission according to the combined modulation order.

Additionally, or alternatively, the communications manager 620 may support wireless communications in accordance with examples as disclosed herein. For example, the communications manager 620 is capable of, configured to, or operable to support a means for identifying a bit mapping scheme associated with a transmission across a set of layers. The communications manager 620 is capable of, configured to, or operable to support a means for receiving the transmission via the set of layers and according to the bit mapping scheme, the bit mapping scheme based on at least two different modulation orders used for at least two corresponding layers in the set of layers. The communications manager 620 is capable of, configured to, or operable to support a means for decoding the transmission according to the bit mapping scheme, where the decoding includes reading a first set of bits associated with a first modulation order used on a first layer and reading a second set of bits associated with a second modulation order used on a second layer.

Additionally, or alternatively, the communications manager 620 may support wireless communications in accordance with examples as disclosed herein. For example, the communications manager 620 is capable of, configured to, or operable to support a means for transmitting, to a receiving device, a grant scheduling a transmission to the receiving device across a set of layers, the grant indicating a combined modulation order associated with the transmission. The communications manager 620 is capable of, configured to, or operable to support a means for transmitting, according to the grant, the transmission via the set of layers and according to the combined modulation order, the combined modulation order based on at least two modulation orders used for at least two corresponding layers in the set of layers, where the at least two modulation orders are within a threshold level of each other.

Additionally, or alternatively, the communications manager 620 may support wireless communications in accordance with examples as disclosed herein. For example, the communications manager 620 is capable of, configured to, or operable to support a means for identifying a bit mapping scheme associated with a transmission across a set of layers. The communications manager 620 is capable of, configured to, or operable to support a means for transmitting the transmission via the set of layers and according to the bit mapping scheme, the bit mapping scheme based on at least two different modulation orders used for at least two corresponding layers in the set of layers, where encoding the transmission according to the bit mapping scheme includes writing a first set of bits associated with a first modulation order used on a first layer and writing a second set of bits associated with a second modulation order used on a second layer.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for asymmetric modulation orders (e.g., combined modulation orders) to be applied to multi-layer transmissions where the modulation orders are within a threshold range of each other. Furthermore, the SBPM techniques may be improved for the multi-layer communications using the combined modulation orders.

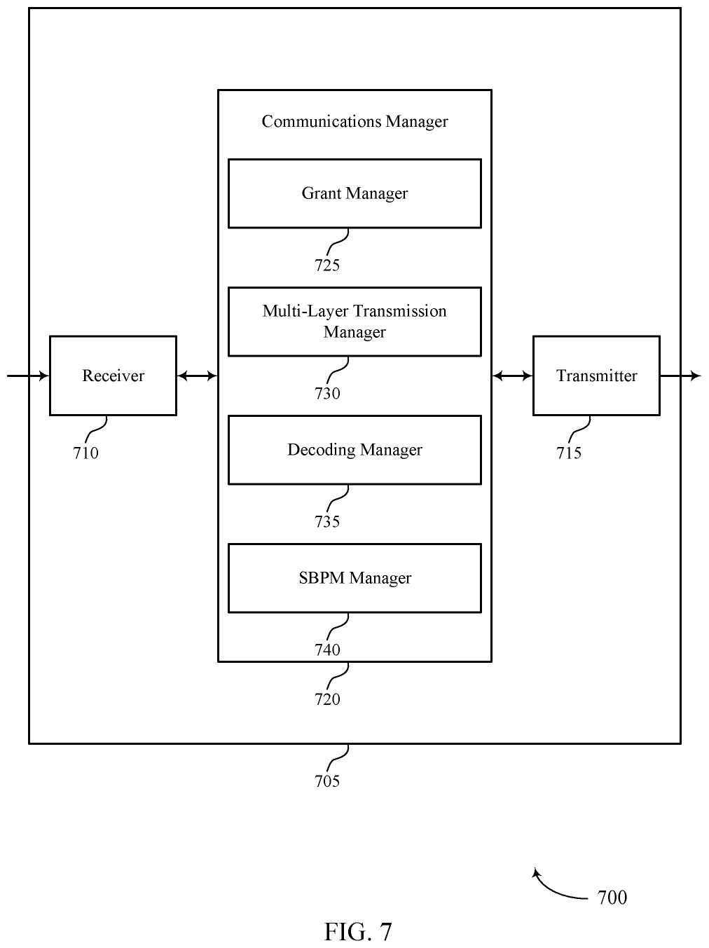

FIG. 7 shows a block diagram 700 of a device 705 that supports asymmetric modulation order design in accordance with one or more aspects of the present disclosure. The device 705 may be an example of aspects of a device 605, a UE 115, or a network entity 105 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to asymmetric modulation order design). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to asymmetric modulation order design). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of asymmetric modulation order design as described herein. For example, the communications manager 720 may include a grant manager 725, a multi-layer transmission manager 730, a decoding manager 735, an SBPM manager 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The grant manager 725 is capable of, configured to, or operable to support a means for receiving a grant scheduling a transmission to the receiving device across a set of layers, the grant indicating a combined modulation order associated with the transmission. The multi-layer transmission manager 730 is capable of, configured to, or operable to support a means for receiving, according to the grant, the transmission via the set of layers and according to the combined modulation order, the combined modulation order based on at least two modulation orders used for at least two corresponding layers in the set of layers, where the at least two modulation orders are within a threshold level of each other. The decoding manager 735 is capable of, configured to, or operable to support a means for decoding the transmission according to the combined modulation order.

Additionally, or alternatively, the communications manager 720 may support wireless communications in accordance with examples as disclosed herein. The SBPM manager 740 is capable of, configured to, or operable to support a means for identifying a bit mapping scheme associated with a transmission across a set of layers. The multi-layer transmission manager 730 is capable of, configured to, or operable to support a means for receiving the transmission via the set of layers and according to the bit mapping scheme, the bit mapping scheme based on at least two different modulation orders used for at least two corresponding layers in the set of layers. The decoding manager 735 is capable of, configured to, or operable to support a means for decoding the transmission according to the bit mapping scheme, where the decoding includes reading a first set of bits associated with a first modulation order used on a first layer and reading a second set of bits associated with a second modulation order used on a second layer.

Additionally, or alternatively, the communications manager 720 may support wireless communications in accordance with examples as disclosed herein. The grant manager 725 is capable of, configured to, or operable to support a means for transmitting, to a receiving device, a grant scheduling a transmission to the receiving device across a set of layers, the grant indicating a combined modulation order associated with the transmission. The multi-layer transmission manager 730 is capable of, configured to, or operable to support a means for transmitting, according to the grant, the transmission via the set of layers and according to the combined modulation order, the combined modulation order based on at least two modulation orders used for at least two corresponding layers in the set of layers, where the at least two modulation orders are within a threshold level of each other.

Additionally, or alternatively, the communications manager 720 may support wireless communications in accordance with examples as disclosed herein. The SBPM manager 740 is capable of, configured to, or operable to support a means for identifying a bit mapping scheme associated with a transmission across a set of layers. The multi-layer transmission manager 730 is capable of, configured to, or operable to support a means for transmitting the transmission via the set of layers and according to the bit mapping scheme, the bit mapping scheme based on at least two different modulation orders used for at least two corresponding layers in the set of layers, where encoding the transmission according to the bit mapping scheme includes writing a first set of bits associated with a first modulation order used on a first layer and writing a second set of bits associated with a second modulation order used on a second layer.

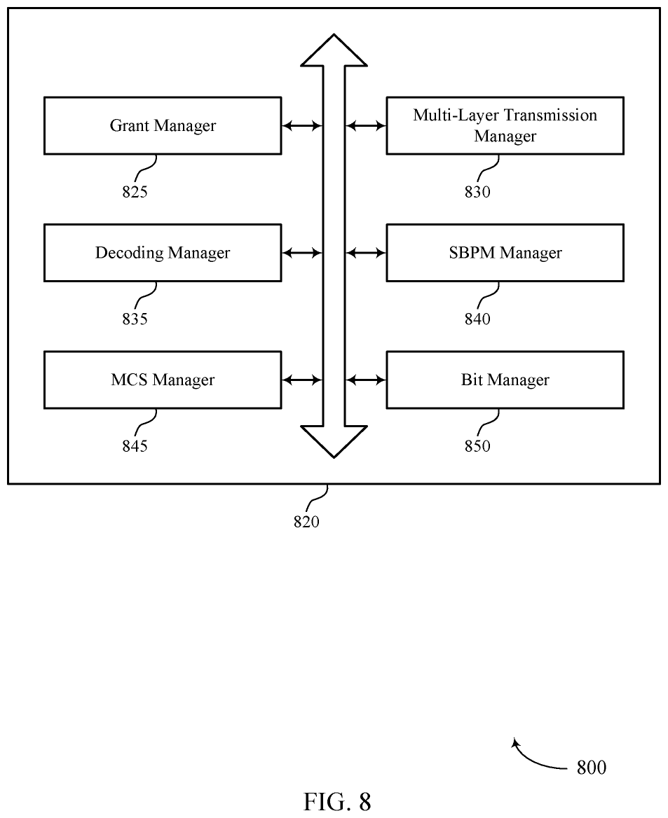

FIG. 8 shows a block diagram 800 of a communications manager 820 that supports asymmetric modulation order design in accordance with one or more aspects of the present disclosure. The communications manager 820 may be an example of aspects of a communications manager 620, a communications manager 720, or both, as described herein. The communications manager 820, or various components thereof, may be an example of means for performing various aspects of asymmetric modulation order design as described herein. For example, the communications manager 820 may include a grant manager 825, a multi-layer transmission manager 830, a decoding manager 835, an SBPM manager 840, an MCS manager 845, a bit manager 850, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The grant manager 825 is capable of, configured to, or operable to support a means for receiving a grant scheduling a transmission to the receiving device across a set of layers, the grant indicating a combined modulation order associated with the transmission. The multi-layer transmission manager 830 is capable of, configured to, or operable to support a means for receiving, according to the grant, the transmission via the set of layers and according to the combined modulation order, the combined modulation order based on at least two modulation orders used for at least two corresponding layers in the set of layers, where the at least two modulation orders are within a threshold level of each other. The decoding manager 835 is capable of, configured to, or operable to support a means for decoding the transmission according to the combined modulation order.

In some examples, the MCS manager 845 is capable of, configured to, or operable to support a means for receiving an indication of a MCS table associated with multi-layer communications, the MCS table including a set of combined modulation orders that includes the combined modulation order. In some examples, each combined modulation order in the set of combined modulation orders is associated with at least two consecutive modulation order levels, a combination of the at least two consecutive modulation order levels forming the combined modulation order.

In some examples, the set of combined modulation orders include a first QPSK modulation and a second QPSK modulation, the first QPSK modulation and a first 16 QAM, the first 16 QAM and a second 16 QAM, the first 16 QAM and a first 64 QAM, the first 64 QAM and a second 64 QAM, the first 64 QAM and a first 256 QAM, the first 256 QAM and a second 256 QAM, the first 256 QAM and a first 1024 QAM, the first 1024 QAM and a second 1024 QAM, the first QAM and a first 4096 QAM, the first 4096 QAM and a second 4096 QAM, or a combination thereof.

In some examples, the MCS manager 845 is capable of, configured to, or operable to support a means for receiving an indication of a MCS table associated with single layer communications, the MCS table including a set of modulation orders corresponding to each single layer communication. In some examples, the MCS manager 845 is capable of, configured to, or operable to support a means for determining the combined modulation order based on the grant, the threshold level, and a spectral efficiency parameter in the MCS table. In some examples, the combined modulation order is associated with at least two consecutive modulation order levels, a combination of the at least two consecutive modulation order levels forming the combined modulation order. In some examples, the at least two modulation orders include at least one of QPSK, QAM, or both. In some examples, the transmission across the set of layers includes a jointly coded and encoded transmission.

Additionally, or alternatively, the communications manager 820 may support wireless communications in accordance with examples as disclosed herein. The SBPM manager 840 is capable of, configured to, or operable to support a means for identifying a bit mapping scheme associated with a transmission across a set of layers. In some examples, the multi-layer transmission manager 830 is capable of, configured to, or operable to support a means for receiving the transmission via the set of layers and according to the bit mapping scheme, the bit mapping scheme based on at least two different modulation orders used for at least two corresponding layers in the set of layers. In some examples, the decoding manager 835 is capable of, configured to, or operable to support a means for decoding the transmission according to the bit mapping scheme, where the decoding includes reading a first set of bits associated with a first modulation order used on a first layer and reading a second set of bits associated with a second modulation order used on a second layer.

In some examples, to support decoding the transmission according to the bit mapping scheme, the bit manager 850 is capable of, configured to, or operable to support a means for reading first MSBs associated with the first modulation order, the first MSBs including the first set of bits. In some examples, to support decoding the transmission according to the bit mapping scheme, the bit manager 850 is capable of, configured to, or operable to support a means for reading second MSBs associated with the second modulation order, the second MSBs including the second set of bits. In some examples, the first MSBs correspond to a first subset of layers that are associated with a first reliability metric and the second MSBs correspond to a second subset of layers that are associated with a second reliability metric that is a lower reliability metric than the first reliability metric.

In some examples, to support decoding the transmission according to the bit mapping scheme, the bit manager 850 is capable of, configured to, or operable to support a means for reading first MSBs associated with the first modulation order, the first MSBs including the first set of bits. In some examples, to support decoding the transmission according to the bit mapping scheme, the bit manager 850 is capable of, configured to, or operable to support a means for reading second MSBs associated with the second modulation order, the second MSBs including the second set of bits.

In some examples, a second column associated with the second modulation order includes a subset of bits corresponding to a puncturing scheme, a rate matching scheme, or a combination thereof. In some examples, the first MSBs are mapped to a first column corresponding to a first subset of layers that are associated with a first reliability metric and the second MSBs are mapped to a second column corresponding to a second subset of layers that are associated with a second reliability metric that is a lower reliability metric than the first reliability metric.

Additionally, or alternatively, the communications manager 820 may support wireless communications in accordance with examples as disclosed herein. In some examples, the grant manager 825 is capable of, configured to, or operable to support a means for transmitting, to a receiving device, a grant scheduling a transmission to the receiving device across a set of layers, the grant indicating a combined modulation order associated with the transmission. In some examples, the multi-layer transmission manager 830 is capable of, configured to, or operable to support a means for transmitting, according to the grant, the transmission via the set of layers and according to the combined modulation order, the combined modulation order based on at least two modulation orders used for at least two corresponding layers in the set of layers, where the at least two modulation orders are within a threshold level of each other.

In some examples, the MCS manager 845 is capable of, configured to, or operable to support a means for transmitting an indication of a MCS table associated with multi-layer communications, the MCS table including a set of combined modulation orders that includes the combined modulation order. In some examples, each combined modulation order in the set of combined modulation orders is associated with at least two consecutive modulation order levels, a combination of the at least two consecutive modulation order levels forming the combined modulation order.

In some examples, the set of combined modulation orders include a first QPSK modulation and a second QPSK modulation, the first QPSK modulation and a first 16 QAM, the first 16 QAM and a second 16 QAM, the first 16 QAM and a first 64 QAM, the first 64 QAM and a second 64 QAM, the first 64 QAM and a first 256 QAM, the first 256 QAM and a second 256 QAM, the first 256 QAM and a first 1024 QAM, the first 1024 QAM and a second 1024 QAM, the first QAM and a first 4096 QAM, the first 4096 QAM and a second 4096 QAM, or a combination thereof.

In some examples, the MCS manager 845 is capable of, configured to, or operable to support a means for transmitting an indication of a MCS table associated with single layer communications, the MCS table including a set of modulation orders corresponding to each communication layer, where the combined modulation order is based on the grant, the threshold level, and a spectral efficiency parameter in the MCS table. In some examples, the combined modulation order is associated with at least two consecutive modulation order levels, a combination of the at least two consecutive modulation order levels forming the combined modulation order. In some examples, the at least two modulation orders include at least one of QPSK, QAM, or both.

Additionally, or alternatively, the communications manager 820 may support wireless communications in accordance with examples as disclosed herein. In some examples, the SBPM manager 840 is capable of, configured to, or operable to support a means for identifying a bit mapping scheme associated with a transmission across a set of layers. In some examples, the multi-layer transmission manager 830 is capable of, configured to, or operable to support a means for transmitting the transmission via the set of layers and according to the bit mapping scheme, the bit mapping scheme based on at least two different modulation orders used for at least two corresponding layers in the set of layers, where encoding the transmission according to the bit mapping scheme includes writing a first set of bits associated with a first modulation order used on a first layer and writing a second set of bits associated with a second modulation order used on a second layer.

In some examples, to support encoding the transmission according to the bit mapping scheme, the bit manager 850 is capable of, configured to, or operable to support a means for writing first MSBs associated with the first modulation order, the first MSBs including the first set of bits. In some examples, to support encoding the transmission according to the bit mapping scheme, the bit manager 850 is capable of, configured to, or operable to support a means for writing second MSBs associated with the second modulation order, the second MSBs including the second set of bits.

In some examples, the first MSBs are mapped to a first row corresponding to a first subset of layers that are associated with a first reliability metric and the second MSBs are mapped to a second row corresponding to a second subset of layers that are associated with a second reliability metric that is a lower reliability metric than the first reliability metric.

In some examples, to support encoding the transmission according to the bit mapping scheme, the bit manager 850 is capable of, configured to, or operable to support a means for writing first MSBs associated with the first modulation order, the first MSBs including the first set of bits. In some examples, to support encoding the transmission according to the bit mapping scheme, the bit manager 850 is capable of, configured to, or operable to support a means for writing second MSBs associated with the second modulation order, the second MSBs including the second set of bits.

In some examples, a second column associated with the second modulation order includes a subset of bits corresponding to a puncturing scheme, a rate matching scheme, or a combination thereof. In some examples, the first MSBs are mapped to a first column corresponding to a first subset of layers that are associated with a first reliability metric and the second MSBs are mapped to a second column corresponding to a second subset of layers that are associated with a second reliability metric that is a lower reliability metric than the first reliability metric.

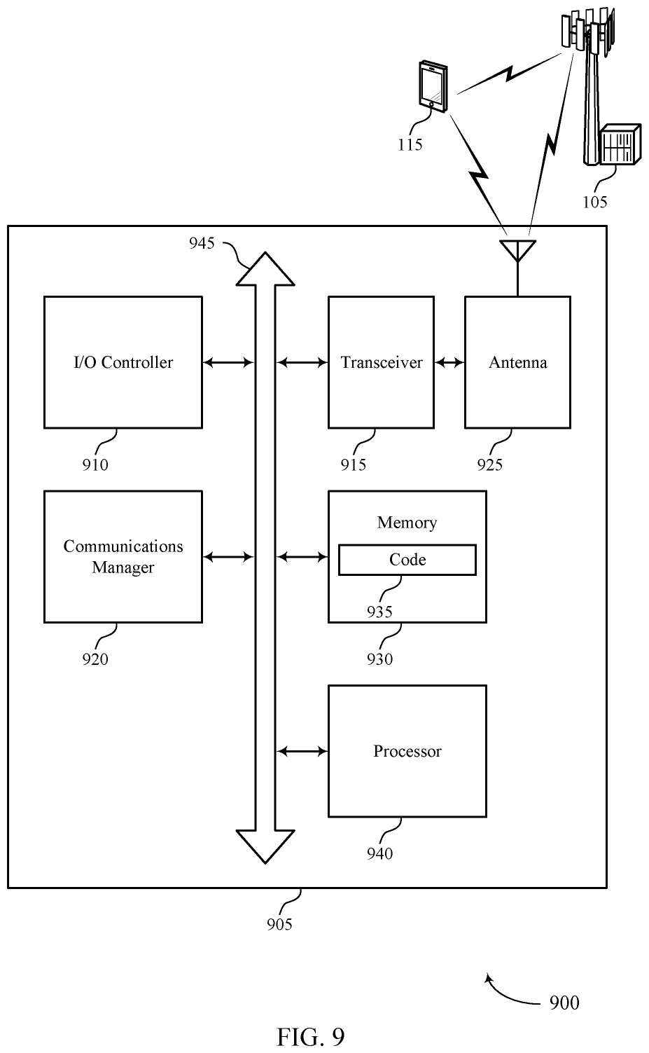

FIG. 9 shows a diagram of a system 900 including a device 905 that supports asymmetric modulation order design in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting asymmetric modulation order design). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a grant scheduling a transmission to the receiving device across a set of layers, the grant indicating a combined modulation order associated with the transmission. The communications manager 920 is capable of, configured to, or operable to support a means for receiving, according to the grant, the transmission via the set of layers and according to the combined modulation order, the combined modulation order based on at least two modulation orders used for at least two corresponding layers in the set of layers, where the at least two modulation orders are within a threshold level of each other. The communications manager 920 is capable of, configured to, or operable to support a means for decoding the transmission according to the combined modulation order.

Additionally, or alternatively, the communications manager 920 may support wireless communications in accordance with examples as disclosed herein. For example, the communications manager 920 is capable of, configured to, or operable to support a means for identifying a bit mapping scheme associated with a transmission across a set of layers. The communications manager 920 is capable of, configured to, or operable to support a means for receiving the transmission via the set of layers and according to the bit mapping scheme, the bit mapping scheme based on at least two different modulation orders used for at least two corresponding layers in the set of layers. The communications manager 920 is capable of, configured to, or operable to support a means for decoding the transmission according to the bit mapping scheme, where the decoding includes reading a first set of bits associated with a first modulation order used on a first layer and reading a second set of bits associated with a second modulation order used on a second layer.

Additionally, or alternatively, the communications manager 920 may support wireless communications in accordance with examples as disclosed herein. For example, the communications manager 920 is capable of, configured to, or operable to support a means for transmitting, to a receiving device, a grant scheduling a transmission to the receiving device across a set of layers, the grant indicating a combined modulation order associated with the transmission. The communications manager 920 is capable of, configured to, or operable to support a means for transmitting, according to the grant, the transmission via the set of layers and according to the combined modulation order, the combined modulation order based on at least two modulation orders used for at least two corresponding layers in the set of layers, where the at least two modulation orders are within a threshold level of each other.

Additionally, or alternatively, the communications manager 920 may support wireless communications in accordance with examples as disclosed herein. For example, the communications manager 920 is capable of, configured to, or operable to support a means for identifying a bit mapping scheme associated with a transmission across a set of layers. The communications manager 920 is capable of, configured to, or operable to support a means for transmitting the transmission via the set of layers and according to the bit mapping scheme, the bit mapping scheme based on at least two different modulation orders used for at least two corresponding layers in the set of layers, where encoding the transmission according to the bit mapping scheme includes writing a first set of bits associated with a first modulation order used on a first layer and writing a second set of bits associated with a second modulation order used on a second layer.

By including or configuring the communications manager 920 in accordance with examples as described herein, the device 905 may support techniques for asymmetric modulation orders (e.g., combined modulation orders) to be applied to multi-layer transmissions where the modulation orders are within a threshold range of each other. Furthermore, the SBPM techniques may be improved for the multi-layer communications using the combined modulation orders.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of asymmetric modulation order design as described herein, or the at least one processor 940 and the at least one memory 930 may be otherwise configured to, individually or collectively, perform or support such operations.

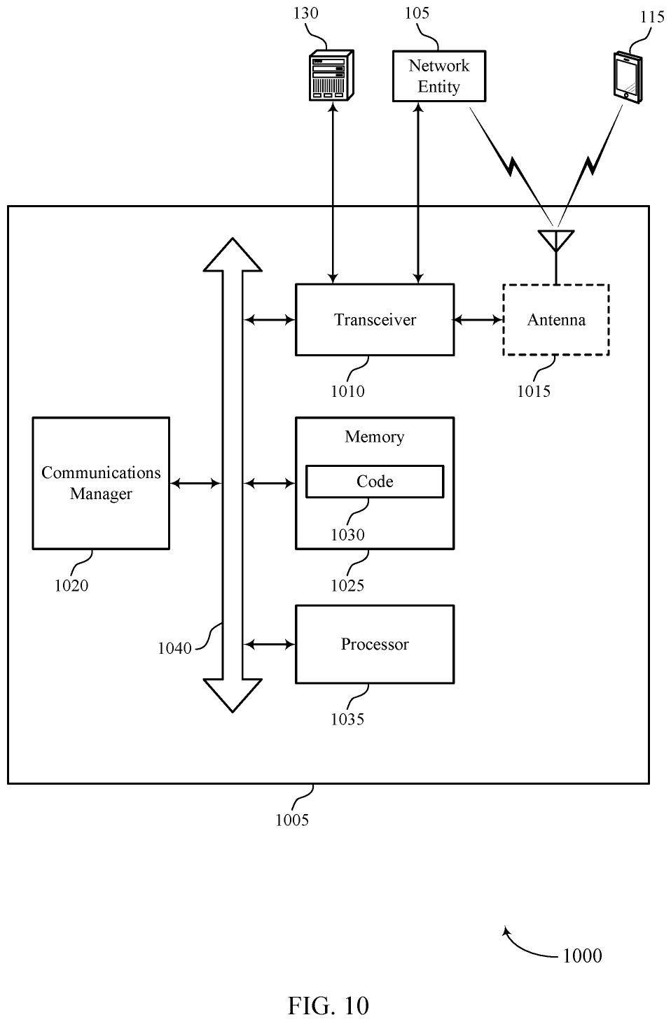

FIG. 10 shows a diagram of a system 1000 including a device 1005 that supports asymmetric modulation order design in accordance with one or more aspects of the present disclosure. The device 1005 may be an example of or include the components of a device 605, a device 705, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., a communication link 125, a backhaul communication link 120, a midhaul communication link 162, a fronthaul communication link 168).

The at least one memory 1025 may include RAM, ROM, or any combination thereof. The at least one memory 1025 may store computer-readable, computer-executable code 1030 including instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may contain, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting asymmetric modulation order design). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025). In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. As such, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for receiving a grant scheduling a transmission to the receiving device across a set of layers, the grant indicating a combined modulation order associated with the transmission. The communications manager 1020 is capable of, configured to, or operable to support a means for receiving, according to the grant, the transmission via the set of layers and according to the combined modulation order, the combined modulation order based on at least two modulation orders used for at least two corresponding layers in the set of layers, where the at least two modulation orders are within a threshold level of each other. The communications manager 1020 is capable of, configured to, or operable to support a means for decoding the transmission according to the combined modulation order.

Additionally, or alternatively, the communications manager 1020 may support wireless communications in accordance with examples as disclosed herein. For example, the communications manager 1020 is capable of, configured to, or operable to support a means for identifying a bit mapping scheme associated with a transmission across a set of layers. The communications manager 1020 is capable of, configured to, or operable to support a means for receiving the transmission via the set of layers and according to the bit mapping scheme, the bit mapping scheme based on at least two different modulation orders used for at least two corresponding layers in the set of layers. The communications manager 1020 is capable of, configured to, or operable to support a means for decoding the transmission according to the bit mapping scheme, where the decoding includes reading a first set of bits associated with a first modulation order used on a first layer and reading a second set of bits associated with a second modulation order used on a second layer.

Additionally, or alternatively, the communications manager 1020 may support wireless communications in accordance with examples as disclosed herein. For example, the communications manager 1020 is capable of, configured to, or operable to support a means for transmitting, to a receiving device, a grant scheduling a transmission to the receiving device across a set of layers, the grant indicating a combined modulation order associated with the transmission. The communications manager 1020 is capable of, configured to, or operable to support a means for transmitting, according to the grant, the transmission via the set of layers and according to the combined modulation order, the combined modulation order based on at least two modulation orders used for at least two corresponding layers in the set of layers, where the at least two modulation orders are within a threshold level of each other.

Additionally, or alternatively, the communications manager 1020 may support wireless communications in accordance with examples as disclosed herein. For example, the communications manager 1020 is capable of, configured to, or operable to support a means for identifying a bit mapping scheme associated with a transmission across a set of layers. The communications manager 1020 is capable of, configured to, or operable to support a means for transmitting the transmission via the set of layers and according to the bit mapping scheme, the bit mapping scheme based on at least two different modulation orders used for at least two corresponding layers in the set of layers, where encoding the transmission according to the bit mapping scheme includes writing a first set of bits associated with a first modulation order used on a first layer and writing a second set of bits associated with a second modulation order used on a second layer.

By including or configuring the communications manager 1020 in accordance with examples as described herein, the device 1005 may support techniques for asymmetric modulation orders (e.g., combined modulation orders) to be applied to multi-layer transmissions where the modulation orders are within a threshold range of each other. Furthermore, the SBPM techniques may be improved for the multi-layer communications using the combined modulation orders.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of asymmetric modulation order design as described herein, or the at least one processor 1035 and the at least one memory 1025 may be otherwise configured to, individually or collectively, perform or support such operations.

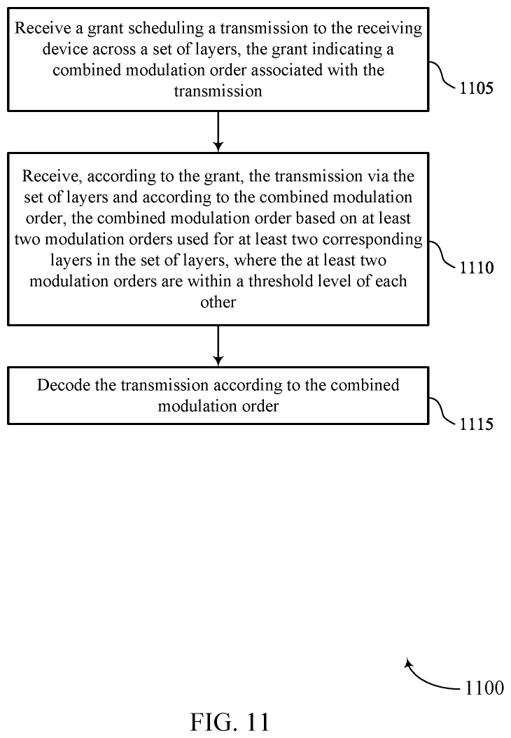

FIG. 11 shows a flowchart illustrating a method 1100 that supports asymmetric modulation order design in accordance with aspects of the present disclosure. The operations of the method 1100 may be implemented by a UE or a network entity or its components as described herein. For example, the operations of the method 1100 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include receiving a grant scheduling a transmission to the receiving device across a set of layers, the grant indicating a combined modulation order associated with the transmission. The operations of block 1105 may be performed in accordance with examples as disclosed herein. In some examples, aspects of the operations of 1105 may be performed by a grant manager 825 as described with reference to FIG. 8.

At 1110, the method may include receiving, according to the grant, the transmission via the set of layers and according to the combined modulation order, the combined modulation order based on at least two modulation orders used for at least two corresponding layers in the set of layers, where the at least two modulation orders are within a threshold level of each other. The operations of block 1110 may be performed in accordance with examples as disclosed herein. In some examples, aspects of the operations of 1110 may be performed by a multi-layer transmission manager 830 as described with reference to FIG. 8.

At 1115, the method may include decoding the transmission according to the combined modulation order. The operations of block 1115 may be performed in accordance with examples as disclosed herein. In some examples, aspects of the operations of 1115 may be performed by a decoding manager 835 as described with reference to FIG. 8.

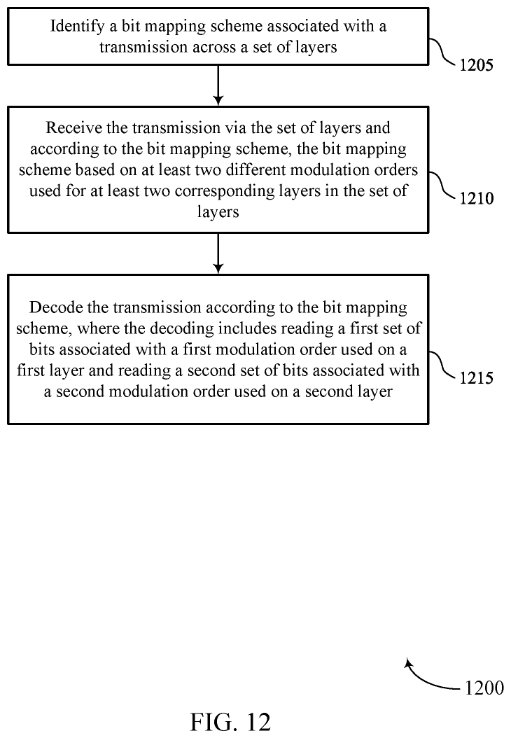

FIG. 12 shows a flowchart illustrating a method 1200 that supports asymmetric modulation order design in accordance with aspects of the present disclosure. The operations of the method 1200 may be implemented by a UE or a network entity or its components as described herein. For example, the operations of the method 1200 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include identifying a bit mapping scheme associated with a transmission across a set of layers. The operations of block 1205 may be performed in accordance with examples as disclosed herein. In some examples, aspects of the operations of 1205 may be performed by an SBPM manager 840 as described with reference to FIG. 8.

At 1210, the method may include receiving the transmission via the set of layers and according to the bit mapping scheme, the bit mapping scheme based on at least two different modulation orders used for at least two corresponding layers in the set of layers. The operations of block 1210 may be performed in accordance with examples as disclosed herein. In some examples, aspects of the operations of 1210 may be performed by a multi-layer transmission manager 830 as described with reference to FIG. 8.

At 1215, the method may include decoding the transmission according to the bit mapping scheme, where the decoding includes reading a first set of bits associated with a first modulation order used on a first layer and reading a second set of bits associated with a second modulation order used on a second layer. The operations of block 1215 may be performed in accordance with examples as disclosed herein. In some examples, aspects of the operations of 1215 may be performed by a decoding manager 835 as described with reference to FIG. 8.

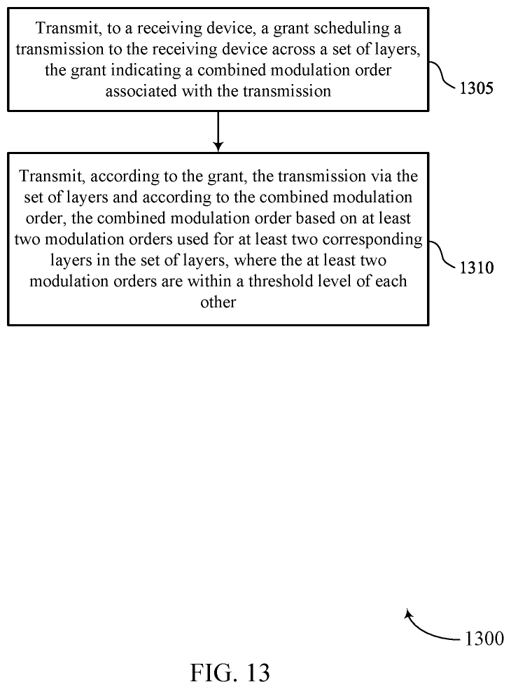

FIG. 13 shows a flowchart illustrating a method 1300 that supports asymmetric modulation order design in accordance with aspects of the present disclosure. The operations of the method 1300 may be implemented by a UE or a network entity or its components as described herein. For example, the operations of the method 1300 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include transmitting, to a receiving device, a grant scheduling a transmission to the receiving device across a set of layers, the grant indicating a combined modulation order associated with the transmission. The operations of block 1305 may be performed in accordance with examples as disclosed herein. In some examples, aspects of the operations of 1305 may be performed by a grant manager 825 as described with reference to FIG. 8.

At 1310, the method may include transmitting, according to the grant, the transmission via the set of layers and according to the combined modulation order, the combined modulation order based on at least two modulation orders used for at least two corresponding layers in the set of layers, where the at least two modulation orders are within a threshold level of each other. The operations of block 1310 may be performed in accordance with examples as disclosed herein. In some examples, aspects of the operations of 1310 may be performed by a multi-layer transmission manager 830 as described with reference to FIG. 8.

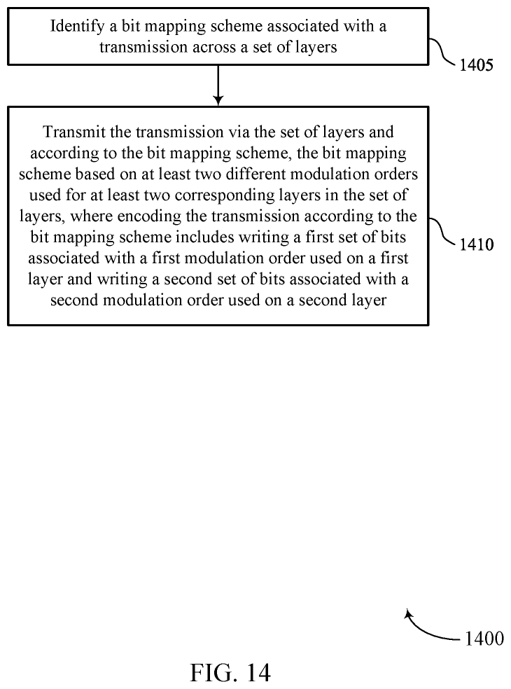

FIG. 14 shows a flowchart illustrating a method 1400 that supports asymmetric modulation order design in accordance with aspects of the present disclosure. The operations of the method 1400 may be implemented by a UE or a network entity or its components as described herein. For example, the operations of the method 1400 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include identifying a bit mapping scheme associated with a transmission across a set of layers. The operations of block 1405 may be performed in accordance with examples as disclosed herein. In some examples, aspects of the operations of 1405 may be performed by an SBPM manager 840 as described with reference to FIG. 8.

At 1410, the method may include transmitting the transmission via the set of layers and according to the bit mapping scheme, the bit mapping scheme based on at least two different modulation orders used for at least two corresponding layers in the set of layers, where encoding the transmission according to the bit mapping scheme includes writing a first set of bits associated with a first modulation order used on a first layer and writing a second set of bits associated with a second modulation order used on a second layer. The operations of block 1410 may be performed in accordance with examples as disclosed herein. In some examples, aspects of the operations of 1410 may be performed by a multi-layer transmission manager 830 as described with reference to FIG. 8.

The following provides an overview of aspects of the present disclosure:
Aspect 1: A method for wireless communications at a receiving device, comprising: receiving a grant scheduling a transmission to the receiving device across a set of layers, the grant indicating a combined modulation order associated with the transmission; receiving the transmission via the set of layers and according to the combined modulation order, the combined modulation order based on at least two modulation orders used for at least two corresponding layers in the set of layers, wherein the at least two modulation orders are within a threshold level of each other; and decoding the transmission according to the combined modulation order.
Aspect 2: The method of aspect 1, further comprising: receiving an indication of a modulation and coding scheme table associated with multi-layer communications, the modulation and coding scheme table comprising a set of combined modulation orders that includes the combined modulation order.
Aspect 3: The method of aspect 2, wherein each combined modulation order in the set of combined modulation orders is associated with at least two consecutive modulation order levels, a combination of the at least two consecutive modulation order levels forming the combined modulation order.
Aspect 4: The method of any of aspects 2 through 3, wherein the set of combined modulation orders comprise a first QPSK modulation and a second QPSK modulation, the first QPSK modulation and a first 16 QAM, the first 16 QAM and a second 16 QAM, the first 16 QAM and a first 64 QAM, the first 64 QAM and a second 64 QAM, the first 64 QAM and a first 256 QAM, the first 256 QAM and a second 256 QAM, the first 256 QAM and a first 1024 QAM, the first 1024 QAM and a second 1024 QAM, the first QAM and a first 4096 QAM, the first 4096 QAM and a second 4096 QAM, or a combination thereof.
Aspect 5: The method of any of aspects 1 through 4, further comprising: receiving an indication of a modulation and coding scheme table associated with single layer communications, the modulation and coding scheme table comprising a set of modulation orders corresponding to each single layer communication; and determining the combined modulation order based on the grant, the threshold level, and a spectral efficiency parameter in the modulation and coding scheme table.
Aspect 6: The method of any of aspects 1 through 5, wherein the combined modulation order is associated with at least two consecutive modulation order levels, a combination of the at least two consecutive modulation order levels forming the combined modulation order.
Aspect 7: The method of any of aspects 1 through 6, wherein the at least two modulation orders comprise at least one of QPSK, QAM, or both.
Aspect 8: The method of any of aspects 1 through 7, wherein the transmission across the set of layers comprises a jointly coded and encoded transmission.
Aspect 9: A method for wireless communications at a receiving device, comprising: identifying a bit mapping scheme associated with a transmission across a set of layers; receiving the transmission via the set of layers and according to the bit mapping scheme, the bit mapping scheme based on at least two different modulation orders used for at least two corresponding layers in the set of layers; and decoding the transmission according to the bit mapping scheme through a read of a first set of bits associated with a first modulation order used on a first layer and a read of a second set of bits associated with a second modulation order used on a second layer.
Aspect 10: The method of aspect 9, wherein decoding the transmission according to the bit mapping scheme comprises: reading first most significant bits associated with the first modulation order, the first most significant bits comprising the first set of bits; and reading second most significant bits associated with the second modulation order, the second most significant bits comprising the second set of bits.
Aspect 11: The method of aspect 10, wherein the first most significant bits correspond to a first subset of layers that are associated with a first reliability metric and the second most significant bits correspond to a second subset of layers that are associated with a second reliability metric that is a lower reliability metric than the first reliability metric.
Aspect 12: The method of any of aspects 9 through 11, wherein decoding the transmission according to the bit mapping scheme comprises: reading first most significant bits associated with the first modulation order, the first most significant bits comprising the first set of bits; and reading second most significant bits associated with the second modulation order, the second most significant bits comprising the second set of bits.
Aspect 13: The method of aspect 12, wherein a second column associated with the second modulation order comprises a subset of bits corresponding to a puncturing scheme, a rate matching scheme, or a combination thereof.
Aspect 14: The method of any of aspects 12 through 13, wherein the first most significant bits are mapped to a first column corresponding to a first subset of layers that are associated with a first reliability metric and the second most significant bits are mapped to a second column corresponding to a second subset of layers that are associated with a second reliability metric that is a lower reliability metric than the first reliability metric.
Aspect 15: A method for wireless communications at a transmitting device, comprising: transmitting, to a receiving device, a grant scheduling a transmission to the receiving device across a set of layers, the grant indicating a combined modulation order associated with the transmission; and transmitting the transmission via the set of layers and according to the combined modulation order, the combined modulation order based on at least two modulation orders used for at least two corresponding layers in the set of layers, wherein the at least two modulation orders are within a threshold level of each other.
Aspect 16: The method of aspect 15, further comprising: transmitting an indication of a modulation and coding scheme table associated with multi-layer communications, the modulation and coding scheme table comprising a set of combined modulation orders that includes the combined modulation order.
Aspect 17: The method of aspect 16, wherein each combined modulation order in the set of combined modulation orders is associated with at least two consecutive modulation order levels, a combination of the at least two consecutive modulation order levels forming the combined modulation order.
Aspect 18: The method of any of aspects 16 through 17, wherein the set of combined modulation orders comprise a first QPSK modulation and a second QPSK modulation, the first QPSK modulation and a first 16 QAM, the first 16 QAM and a second 16 QAM, the first 16 QAM and a first 64 QAM, the first 64 QAM and a second 64 QAM, the first 64 QAM and a first 256 QAM, the first 256 QAM and a second 256 QAM, the first 256 QAM and a first 1024 QAM, the first 1024 QAM and a second 1024 QAM, the first QAM and a first 4096 QAM, the first 4096 QAM and a second 4096 QAM, or a combination thereof.
Aspect 19: The method of any of aspects 15 through 18, further comprising: transmitting an indication of a modulation and coding scheme table associated with single layer communications, the modulation and coding scheme table comprising a set of modulation orders corresponding to each communication layer, wherein the combined modulation order is based on the grant, the threshold level, and a spectral efficiency parameter in the modulation and coding scheme table.
Aspect 20: The method of any of aspects 15 through 19, wherein the combined modulation order is associated with at least two consecutive modulation order levels, a combination of the at least two consecutive modulation order levels forming the combined modulation order.
Aspect 21: The method of any of aspects 15 through 20, wherein the at least two modulation orders comprise at least one of QPSK, QAM, or both.
Aspect 22: A method for wireless communications at a transmitting device, comprising: identifying a bit mapping scheme associated with a transmission across a set of layers; and transmitting the transmission via the set of layers and according to the bit mapping scheme, the bit mapping scheme based on at least two different modulation orders used for at least two corresponding layers in the set of layers, wherein to encode the transmission according to the bit mapping scheme is through a write of a first set of bits associated with a first modulation order used on a first layer and a write of a second set of bits associated with a second modulation order used on a second layer.
Aspect 23: The method of aspect 22, wherein encoding the transmission according to the bit mapping scheme comprises: writing first most significant bits associated with the first modulation order, the first most significant bits comprising the first set of bits; and writing second most significant bits associated with the second modulation order, the second most significant bits comprising the second set of bits.
Aspect 24: The method of aspect 23, wherein the first most significant bits are mapped to a first row corresponding to a first subset of layers that are associated with a first reliability metric and the second most significant bits are mapped to a second row corresponding to a second subset of layers that are associated with a second reliability metric that is a lower reliability metric than the first reliability metric.
Aspect 25: The method of any of aspects 22 through 24, wherein encoding the transmission according to the bit mapping scheme comprises: writing first most significant bits associated with the first modulation order, the first most significant bits comprising the first set of bits; and writing second most significant bits associated with the second modulation order, the second most significant bits comprising the second set of bits.
Aspect 26: The method of aspect 25, wherein a second column associated with the second modulation order comprises a subset of bits corresponding to a puncturing scheme, a rate matching scheme, or a combination thereof.
Aspect 27: The method of any of aspects 25 through 26, wherein the first most significant bits are mapped to a first column corresponding to a first subset of layers that are associated with a first reliability metric and the second most significant bits are mapped to a second column corresponding to a second subset of layers that are associated with a second reliability metric that is a lower reliability metric than the first reliability metric.
Aspect 28: A receiving device for wireless communications, comprising one or more memories storing processor-executable code, and one or more processors coupled with the one or more memories and individually or collectively operable to execute the code to cause the receiving device to perform a method of any of aspects 1 through 8.
Aspect 29: A receiving device for wireless communications, comprising at least one means for performing a method of any of aspects 1 through 8.
Aspect 30: A non-transitory computer-readable medium storing code for wireless communications, the code comprising instructions executable by a processor to perform a method of any of aspects 1 through 8.
Aspect 31: A receiving device for wireless communications, comprising one or more memories storing processor-executable code, and one or more processors coupled with the one or more memories and individually or collectively operable to execute the code to cause the receiving device to perform a method of any of aspects 9 through 14.
Aspect 32: A receiving device for wireless communications, comprising at least one means for performing a method of any of aspects 9 through 14.
Aspect 33: A non-transitory computer-readable medium storing code for wireless communications, the code comprising instructions executable by a processor to perform a method of any of aspects 9 through 14.
Aspect 34: A transmitting device for wireless communications, comprising one or more memories storing processor-executable code, and one or more processors coupled with the one or more memories and individually or collectively operable to execute the code to cause the transmitting device to perform a method of any of aspects 15 through 21.
Aspect 35: A transmitting device for wireless communications, comprising at least one means for performing a method of any of aspects 15 through 21.
Aspect 36: A non-transitory computer-readable medium storing code for wireless communications, the code comprising instructions executable by a processor to perform a method of any of aspects 15 through 21.
Aspect 37: A transmitting device for wireless communications, comprising one or more memories storing processor-executable code, and one or more processors coupled with the one or more memories and individually or collectively operable to execute the code to cause the transmitting device to perform a method of any of aspects 22 through 27.
Aspect 38: A transmitting device for wireless communications, comprising at least one means for performing a method of any of aspects 22 through 27.
Aspect 39: A non-transitory computer-readable medium storing code for wireless communications, the code comprising instructions executable by a processor to perform a method of any of aspects 22 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A receiving device, comprising:
one or more memories storing processor-executable code; and
one or more processors coupled with the one or more memories and individually or collectively operable to execute the code to cause the receiving device to:
receive a grant scheduling a transmission to the receiving device across a set of layers, the grant indicating a combined modulation order associated with the transmission;
receive the transmission via the set of layers and according to the combined modulation order, the combined modulation order based on at least two modulation orders used for at least two corresponding layers in the set of layers, wherein the at least two modulation orders are within a threshold level of each other; and
decode the transmission according to the combined modulation order.

2. The receiving device of claim 1, wherein the one or more processors are individually or collectively further operable to execute the code to cause the receiving device to:
receive an indication of a modulation and coding scheme table associated with multi-layer communications, the modulation and coding scheme table comprising a set of combined modulation orders that includes the combined modulation order, wherein, to decode the transmission, the one or more processors are individually or collectively operable to execute the code to cause the receiving device to decode the transmission based at least in part on the modulation and coding scheme table.

3. The receiving device of claim 2, wherein each combined modulation order in the set of combined modulation orders is associated with at least two consecutive modulation order levels, a combination of the at least two consecutive modulation order levels forming the combined modulation order.

4. The receiving device of claim 2, wherein the set of combined modulation orders comprise a first quadrature phase-shift keying (QPSK) modulation and a second QPSK modulation, the first QPSK modulation and a first 16 quadrature amplitude modulation (QAM), the first 16 QAM and a second 16 QAM, the first 16 QAM and a first 64 QAM, the first 64 QAM and a second 64 QAM, the first 64 QAM and a first 256 QAM, the first 256 QAM and a second 256 QAM, the first 256 QAM and a first 1024 QAM, the first 1024 QAM and a second 1024 QAM, the first QAM and a first 4096 QAM, the first 4096 QAM and a second 4096 QAM, or a combination thereof.

5. The receiving device of claim 1, wherein the one or more processors are individually or collectively further operable to execute the code to cause the receiving device to:
receive an indication of a modulation and coding scheme table associated with single layer communications, the modulation and coding scheme table comprising a set of modulation orders corresponding to each single layer communication; and
determine the combined modulation order based on the grant, the threshold level, and a spectral efficiency parameter in the modulation and coding scheme table.

6. The receiving device of claim 1, wherein the combined modulation order is associated with at least two consecutive modulation order levels, a combination of the at least two consecutive modulation order levels forming the combined modulation order.

7. The receiving device of claim 1, wherein the at least two modulation orders comprise at least one of quadrature phase-shift keying (QPSK), quadrature amplitude modulation (QAM), or both.

8. The receiving device of claim 1, wherein the transmission across the set of layers comprises a jointly coded and encoded transmission.

9. A receiving device, comprising:
one or more memories storing processor-executable code; and
one or more processors coupled with the one or more memories and individually or collectively operable to execute the code to cause the receiving device to:
identify a bit mapping scheme associated with a transmission across a set of layers;
receive the transmission via the set of layers and according to the bit mapping scheme, the bit mapping scheme based on at least two different modulation orders used for at least two corresponding layers in the set of layers; and
decode the transmission according to the bit mapping scheme through a read of a first set of bits associated with a first modulation order used on a first layer and a read of a second set of bits associated with a second modulation order used on a second layer.

10. The receiving device of claim 9, wherein, to decode the transmission according to the bit mapping scheme, the one or more processors are individually or collectively operable to execute the code to cause the receiving device to:
read first most significant bits associated with the first modulation order, the first most significant bits comprising the first set of bits; and
read second most significant bits associated with the second modulation order, the second most significant bits comprising the second set of bits.

11. The receiving device of claim 10, wherein the first most significant bits correspond to a first subset of layers that are associated with a first reliability metric and the second most significant bits correspond to a second subset of layers that are associated with a second reliability metric that is a lower reliability metric than the first reliability metric.

12. The receiving device of claim 9, wherein, to decode the transmission according to the bit mapping scheme, the one or more processors are individually or collectively operable to execute the code to cause the receiving device to:
read first most significant bits associated with the first modulation order, the first most significant bits comprising the first set of bits; and
read second most significant bits associated with the second modulation order, the second most significant bits comprising the second set of bits.

13. The receiving device of claim 12, wherein a second column associated with the second modulation order comprises a subset of bits corresponding to a puncturing scheme, a rate matching scheme, or a combination thereof.

14. The receiving device of claim 12, wherein the first most significant bits are mapped to a first column corresponding to a first subset of layers that are associated with a first reliability metric and the second most significant bits are mapped to a second column corresponding to a second subset of layers that are associated with a second reliability metric that is a lower reliability metric than the first reliability metric.

15. A transmitting device, comprising:
one or more memories storing processor-executable code; and
one or more processors coupled with the one or more memories and individually or collectively operable to execute the code to cause the transmitting device to:
transmit, to a receiving device, a grant scheduling a transmission to the receiving device across a set of layers, the grant indicating a combined modulation order associated with the transmission; and
transmit the transmission via the set of layers and according to the combined modulation order, the combined modulation order based on at least two modulation orders used for at least two corresponding layers in the set of layers, wherein the at least two modulation orders are within a threshold level of each other.

16. The transmitting device of claim 15, wherein the one or more processors are individually or collectively further operable to execute the code to cause the transmitting device to:
transmit an indication of a modulation and coding scheme table associated with multi-layer communications, the modulation and coding scheme table comprising a set of combined modulation orders that includes the combined modulation order, wherein, to decode the transmission, the one or more processors are individually or collectively operable to execute the code to cause the transmitting device to decode the transmission based at least in part on the modulation and coding scheme table.

17. The transmitting device of claim 16, wherein each combined modulation order in the set of combined modulation orders is associated with at least two consecutive modulation order levels, a combination of the at least two consecutive modulation order levels forming the combined modulation order.

18. The transmitting device of claim 16, wherein the set of combined modulation orders comprise a first quadrature phase-shift keying (QPSK) modulation and a second QPSK modulation, the first QPSK modulation and a first 16 quadrature amplitude modulation (QAM), the first 16 QAM and a second 16 QAM, the first 16 QAM and a first 64 QAM, the first 64 QAM and a second 64 QAM, the first 64 QAM and a first 256 QAM, the first 256 QAM and a second 256 QAM, the first 256 QAM and a first 1024 QAM, the first 1024 QAM and a second 1024 QAM, the first QAM and a first 4096 QAM, the first 4096 QAM and a second 4096 QAM, or a combination thereof.

19. The transmitting device of claim 15, wherein the one or more processors are individually or collectively further operable to execute the code to cause the transmitting device to:
transmit an indication of a modulation and coding scheme table associated with single layer communications, the modulation and coding scheme table comprising a set of modulation orders corresponding to each communication layer, wherein the combined modulation order is based on the grant, the threshold level, and a spectral efficiency parameter in the modulation and coding scheme table.

20. The transmitting device of claim 15, wherein the combined modulation order is associated with at least two consecutive modulation order levels, a combination of the at least two consecutive modulation order levels forming the combined modulation order.

21. The transmitting device of claim 15, wherein the at least two modulation orders comprise at least one of quadrature phase-shift keying (QPSK), quadrature amplitude modulation (QAM), or both.

22. A transmitting device, comprising:
one or more memories storing processor-executable code; and
one or more processors coupled with the one or more memories and individually or collectively operable to execute the code to cause the transmitting device to:
identify a bit mapping scheme associated with a transmission across a set of layers; and
transmit the transmission via the set of layers and according to the bit mapping scheme, the bit mapping scheme based on at least two different modulation orders used for at least two corresponding layers in the set of layers, wherein to encode the transmission according to the bit mapping scheme is through a write of a first set of bits associated with a first modulation order used on a first layer and a write of a second set of bits associated with a second modulation order used on a second layer.

23. The transmitting device of claim 22, wherein, to encode the transmission according to the bit mapping scheme, the one or more processors are individually or collectively operable to execute the code to cause the transmitting device to:
write first most significant bits associated with the first modulation order, the first most significant bits comprising the first set of bits; and
write second most significant bits associated with the second modulation order, the second most significant bits comprising the second set of bits.

24. The transmitting device of claim 23, wherein the first most significant bits are mapped to a first row corresponding to a first subset of layers that are associated with a first reliability metric and the second most significant bits are mapped to a second row corresponding to a second subset of layers that are associated with a second reliability metric that is a lower reliability metric than the first reliability metric.

25. The transmitting device of claim 22, wherein, to encode the transmission according to the bit mapping scheme, the one or more processors are individually or collectively operable to execute the code to cause the transmitting device to:
write first most significant bits associated with the first modulation order, the first most significant bits comprising the first set of bits; and
write second most significant bits associated with the second modulation order, the second most significant bits comprising the second set of bits.

26. The transmitting device of claim 25, wherein a second column associated with the second modulation order comprises a subset of bits corresponding to a puncturing scheme, a rate matching scheme, or a combination thereof.

27. The transmitting device of claim 25, wherein the first most significant bits are mapped to a first column corresponding to a first subset of layers that are associated with a first reliability metric and the second most significant bits are mapped to a second column corresponding to a second subset of layers that are associated with a second reliability metric that is a lower reliability metric than the first reliability metric.
